(19) United States
(12) Patent Application Publication
(10) Pub. No.: US 2016/0356469 A1
(43) Pub. Date: Dec. 8, 2016

(54) SUPPLEMENTAL, BACKUP OR EMERGENCY LIGHTING SYSTEMS AND METHODS

(71) Applicant: FULHAM COMPANY LIMITED, an exempted company incorporated with limited liability under the laws, George Town (KY)

(72) Inventors: Alvaro Garcia, Torrance, CA (US); Brian Soderholm, Snellville, GA (US); Thomas E. Woods, Huntington Beach, CA (US)

(73) Assignee: FULHAM COMPANY LIMITED, an exempted company incorporated with limited liability under the laws, George Town (KY)

(21) Appl. No.: 15/018,535

(22) Filed: Feb. 8, 2016

Related U.S. Application Data
(63) Continuation of application No. 13/318,143, filed on Jul. 19, 2012, now abandoned.
(60) Provisional application No. 61/174,649, filed on May 1, 2009.

(51) Int. Cl. F21V 23/06; F21V 23/02; H02J 7/00; H05B 33/08; H02J 9/02; F21S 9/02; F21V 23/00

(52) U.S. Cl. CPC F21V 23/06; F21S 9/022; F21V 23/02; F21V 23/003; H05B 33/0815; H05B 33/0887; H05B 33/0845; H02J 9/02; H02J 7/0052; F21Y 2105/10

(57) ABSTRACT

A supplemental lighting system includes a charging circuit having a reference voltage for the charging circuit set through changes to reference resistances, and/or having an output voltage, current or power set through a connector configuration. In one example, a battery storage connector can be used to select a particular resistance for setting the reference voltage. Additionally, a supplemental lighting system may have a rechargeable battery coupled to a low-voltage part of the circuit, for example protected by an isolation circuit. Furthermore, a lithium ion or similar rechargeable battery supply can include a circuit for allowing it to be used with a circuit designed for a NiCad powered system or with a circuit designed for a lithium ion powered system.

### CROSS REFERENCE TO RELATED APPLICATIONS

This is a continuation of U.S. Ser. No. 13/318,143, filed Jul. 19, 2012, which is a National Stage of International Application No. PCT/US10/33443, filed May 3, 2010, incorporated herein by reference, which claims priority from U.S. 61/174,649 filed May 1, 2009.

### BACKGROUND

Field

This relates to supplemental lighting, including for example backup lighting, emergency lighting and similar supplemental lighting systems and methods. This also relates to rechargeable battery assemblies.

Related Art

A number of backup and emergency lighting systems include battery or power backup assemblies tapped into a part of a lighting circuit. The assemblies typically include a battery or other storage device typically charged through main power supply during normal operation. When the assembly is activated or triggered, for example by a power outage, brownout, or other condition, power is supplied to the normal lighting system through the driving circuit used to drive the lighting system during normal operation. Such a connection may create a more complicated wiring arrangement and possibly lead to connection errors. While the backup system may be designed for providing power backup, the backup system is powering a light source generally designed primarily for normal lighting operation.

Installation of backup or emergency lighting system into pre-existing lighting systems generally requires substantial retrofit. The backup or emergency lighting system requires tapping into and interrupting the circuits of the pre-existing lighting system. A number of electrical connections must be disassembled and reconnected with the backup or emergency lighting system, with the attendant probability for errors. Additionally, with a wide variety of existing lighting configurations, the physical placement of the backup or emergency lighting system may require excessive physical modification of housings and/or surrounding support structure.

Standalone backup or emergency lighting systems are well known. Such systems are generally placed separately from the normal, everyday lighting system, and generally include their own mounting structures, wiring conduit, and the like. Design and installation of standalone backup or emergency lighting systems in new structures typically require support structures and installation procedures separate from the normal day-to-day lighting system. Retrofit of existing structures for backup or emergency lighting systems sometimes requires separate mounting arrangements and separate wiring designs, separate from the mounting and wiring of the day-to-day lighting system.

### SUMMARY

Methods and apparatus are disclosed for a supplemental lighting system, for example emergency or backup lighting, that can be easy to install, more versatile, and less prone to user error. One or more of the examples can be used for path lighting and egress lighting, and can operate with their own power and light sources independently of existing or everyday lighting systems, such as those controlled by wall switches, timers or other controls. One or more of the examples can also be installed independently of an existing lighting, and sometimes even in the same housing or “envelope” of an existing lighting unit. Additionally, one or more of the examples can be implemented with existing power sources by tapping directly into the main power supply independent of control switches and the like used for controlling everyday lighting systems. Furthermore, one or more of the present examples can be implemented in a new installation, or can be retrofitted into an existing structure. In the example of a retrofit, in one example, the supplemental lighting system can be installed without having to make connections with the existing lighting system, but instead making a connection to the main power source. In one example of a retrofit, such as for a down light, an existing trim ring can be replaced with a new trim ring incorporating the light sources of the supplemental lighting system along with the electronics. In another example of a retrofit, such as a linear lighting system, the supplemental lighting system can be attached to the existing fixture housing with a tap going back to the main power source. These and other aspects of the examples will be apparent from the following description and drawings.

In one example of a method and apparatus described herein, a lighting system is provided having an electric storage element, for example a battery supply, with an element, for example a connector, for electrically coupling an electric storage element to an electrical circuit configured for powering a light source in the lighting system. The coupling element may be a plug and socket combination, a switch arrangement, or other means for electrically coupling an electric storage element to the electrical circuit. The coupling element can be used, for example, to indicate or signal to the lighting system the configuration or characteristics of the storage element being coupled to the lighting system. In one example, the coupling element can be used to couple batteries of different characteristics, such as different capacities, to allow a given battery to supply current at a common voltage to the electrical circuit. The coupling element can be used to adapt to different battery characteristics, such as battery capacities, for example to make the system more versatile or adaptive. The coupling element can be used as an indicator for causing the lighting system to set an appropriate circuit configuration, for example one of several reference voltages, for accommodating batteries of different voltages so that batteries of different capacity ratings can be used in the same circuit. In other examples, the coupling element can be used to couple and adapt to storage elements of different chemistries, such as Nickel Metal Hydride batteries, Nickel Cadmium batteries and Lithium ion batteries. Different storage element chemistries may require different charging settings for the charging circuit, such as voltage and current and capacity, for example. Such information can be communicated to the lighting system through the coupling element. Furthermore, a Lithium Ion rechargeable battery supply can include a circuit for allowing it to be used with a circuit designed for a NiCad powered system or with a circuit designed for a lithium ion powered system, and such configuration if desired can be communicated to the lighting system. The form of the communication can be selected as desired. For example, the information can be communicated by changing an analog setting in electronics of the lighting system, or the information can be communicated by conveying digital information to a processor, register or other digital device in the lighting system. A further form of communication of the information to the lighting system is mechanical, such as by changing a switch configuration, which may then change an electrical or digital setting in the lighting system, for example.

In another example of a method and apparatus described herein, a lighting system having an electric storage element, for example a battery supply, with a coupling element for electrically coupling the storage element to an electrical circuit is configured for powering a light source in the lighting system. The coupling element may include connection elements having at least two separate contact elements, each for setting the electrical circuit to correspond to a respective battery capacity. For example, if the system is configured to accommodate two different battery capacities, the coupling element may include connection locations corresponding to two separate circuit elements in the electrical circuit, each corresponding to a respective circuit configuration. In one example, the two separate contact elements correspond to respective different resistors as part of a voltage reference circuit for charging different electric storage elements. In another example, if the system is configured to accommodate three different battery capacities, the coupling element may include connection elements having three separate contact elements, and each for setting the electrical circuit according to respective different resistors in the circuit. In this example, as well as other possible examples, the coupling element also includes two active contact elements for coupling the electric storage element to a circuit for supplying current to the light source from the storage element. In some of the examples described herein, the light source is an LED light source, LED array or other LED configurations, or other light sources. LED light sources are acceptable components as they are low-voltage components.

In another example of a method and apparatus described herein, a lighting system is provided with a rechargeable electrical storage element and an isolation system in an electrical circuit. The isolation system is between a power supply circuit and a light powering circuit, for example to provide a measure of isolation for the light powering circuit from the power supply circuit. The rechargeable electrical storage element, for example a battery, is electrically coupled to the light powering circuit for charging the storage element, and also for powering the light source. In one example, the isolation system is an isolation transformer. In one example, an isolation transformer serving as the isolation system separates a power supply circuit capable of being set for different configurations, such as different reference voltage settings, from the light powering circuit used to drive a low-voltage LED light source or assembly. In another example, the power supply circuit is configured to be coupled to a main power supply and includes a circuit or circuits allowing setting of different reference voltages, and may include an integrated circuit element. Other configurations of power supply circuit and/or light powering circuit can be used.

In another example of a method and apparatus described herein, a rechargeable electrical storage element, in one example a battery, and for example that may be used in a supplemental lighting systems such as those described herein, includes an electrical coupling element having a first number of discrete electrical contact elements and a second larger number of discrete electrical contact positions at least one of which lacks an active electrical contact element. In one example, the storage element includes a connector having a number of openings or slots for making a respective number of electrical connections, but at least one of them lacks any electrical contact element. For example, the connector may have six openings or slots for making possible electrical connections, but only four are active with respective functioning electrical contact elements. In another example, the connector may have seven openings or slots for making possible electrical connections, but only four are with active respective electrical contact elements. In this example, the connector and storage element may be connected into a circuit of one or more of the lighting systems described herein, with two of the electrical contact elements coupling with corresponding active contact elements in a charging circuit of the lighting system, and two others of the electrical contact elements coupling with corresponding active contact elements in a power supply circuit of the lighting system, for example to set a circuit configuration such as a reference voltage. Also in this example, the mating connector of the lighting system may include additional active electrical contact elements for electrically coupling with corresponding contact elements in other storage element assemblies, such as those having other capacity ratings, for example. Such connectors would allow different battery types to be used in a single, more versatile lighting system, for example without requiring any rewiring or changing of the circuit design of the lighting system. A number of battery types can be used with the lighting system, simply by installing the desired battery type, or by removing the existing battery type and replacing it with a different battery type.

In the examples of the method and apparatus described in the immediately preceding paragraph, the mating connector of the lighting system may include openings or slots for mating with the connector and storage element. The openings or slots may include active electrical contact elements in selected openings or slots corresponding to active electrical contact elements in the connector for the storage element configurations expected to be used with the lighting system. In a first example, a first predetermined opening or slot may include an active electrical contact element coupled to the common input line of the lighting system, and every connector and storage element combination to be used with the lighting system must have at least an active contact corresponding to the first opening or slot of the lighting system. Any connector not having an active contact in the first opening or slot would not operate with the lighting system. This configuration of coding or predetermined characteristic of a connector would have all configurations sharing an opening or slot, and the uniqueness between configurations arises from others of active or inactive openings or slots. This configuration of coding or predetermined characteristic of a connector would be positional in nature. Additionally, for each storage element configuration permitted to be used with the lighting system, the storage element connector will include an active electrical contact element corresponding to the first opening or slot and at least a second active electrical contact element in a respective second opening or slot in the lighting system connector. Therefore, in the lighting system, the lighting system connector will include as many additional active electrical contact elements as there are different storage elements to be used with the lighting system. For example, if only one storage element configuration is to be used with the lighting system, the connector for the lighting system will have active electrical contact elements corresponding to the first opening or slot and one other opening or slot, for example to set a circuit configuration such as a reference voltage. If two storage element configurations are to be used with the lighting system and no others, the lighting system connector will have active electrical contact elements corresponding to the first opening or slot and corresponding to two other openings or slots. Likewise, only proper storage elements designed to be used with the lighting system will have connectors with active electrical contact elements in the positions corresponding to the active electrical contact elements in the lighting system connector.

In a second example, any two slots or openings can include active electrical contact elements coupled in the lighting system to accommodate a respective connector and storage element configuration. In this example, the first slot or opening does not necessarily correspond to a common input line of the lighting system, but instead the circuit of the lighting system is configured so that the placement of active electrical contact elements in the lighting system connector achieves the desired coupling of the storage element into the lighting system for the desired effect. For example, active electrical contact elements in the first and second slots or openings may correspond to a first storage element configuration, active electrical contact elements in the second and third to a second storage element configuration, and active electrical contact elements in the first and third to a third storage element configuration, corresponding to respective first, second or third circuit configurations in the lighting system. This configuration of coding or predetermined characteristic of a connector would have the uniqueness between configurations also arising from positional or location differences between openings or slots for one configuration versus another.

In a third example, respective active electrical contact elements in the connector for the lighting system are coupled into the lighting system circuit in the same way for all storage element configurations, for example in the first and second openings or slots, and the storage element and its connector include a respective indicator corresponding only to that particular storage element configuration. For example, the lighting system connector includes active electrical contact elements in first and second slots or openings (for example first and second in line from an end of the connector), and each different storage element configuration includes a different resistor unique to that storage element. For example, the storage element may be a battery with a connector having a 100 ohm resistor, while a different storage element may be a battery with a connector having a 1,000 ohm resistor and a third different storage element may be a battery with a connector having a 10,000 ohm resistor. In another example, the storage element may include additional components coupled to the active electrical contact elements in the connector for providing suitable information to the lighting system. An example of such additional components may be those such as used in conjunction with SM bus technology. Use of resistors or similar electronic components may be considered passive components. Other examples may use active components, such as SM Bus technology or similar active components. This configuration of coding or predetermined characteristic of a connector would have the uniqueness between configurations arising from electronic differences between one or more openings or slots for one configuration versus another. In the examples described herein, the electronic differences producing the uniqueness are incorporated into the connector or coupling element for the storage element. In any of the foregoing configurations, the lighting system connector may also include other active elements for other purposes, for example to receive current from a storage element. Additionally in any of the foregoing configurations, the storage element connectors include active electrical contact elements corresponding to the particular storage element configuration to be used with the lighting system.

In another example of a method and apparatus described herein, a lighting system such as those described herein can include a connection element or coupling element for coupling a light source to a driver or energizing system for the light source. The connection element or coupling element includes an indicator element for indicating to the driver or energizing system a type or configuration or a characteristic of light source that is being coupled to the driver or energizing system. In the examples of LED light sources, the light sources can be in the form of arrays, and the connection element or coupling element can indicate to the driver or energizing system the size of the array, the type of array, a form of energy to be used to drive the array, for example a particular voltage, current or power level, or other characteristics of the array to be indicated or communicated to the driver or energizing system. In examples of other light sources, the connection element or coupling element can be used to indicate to the driver or energizing system characteristics of the light source. In any of the examples of light source connectors, differentiation between different light source configurations can be accomplished by connector positional differences or connector electronic differences, and for electronic differences, the differences can be incorporated into the connector forming part of the light source.

In one example of a method and apparatus of a lighting system with a connection element or coupling element having an indicator element, the connection element or coupling element can have a first number of discrete electrical contact elements and a second larger number of discrete electrical contact positions at least one of which lacks an active electrical contact element. In one example, the light source includes a connector having a number of openings or slots for making a respective number of electrical connections, but at least one of them lacks any electrical contact element. For example, the connector may have four openings or slots for making possible electrical connections, but only two are active with respective functioning electrical contact elements for energizing or driving the light source. The other two openings or slots are configured for indicating to the driver or energizing source a configuration or other characteristic of the light source. In this example, the connector and light source may be connected into a circuit (either separately or together in a single connection), with two of the electrical contact elements coupling with corresponding active contact elements in a light source driving circuit of the lighting system, and two others of the electrical contact elements coupling with corresponding active contact elements in a light source driving circuit, for example to set a circuit configuration such as a current, voltage or power, for example for driving the light source. A number of light source types or configurations can be used with the lighting system, simply by installing the desired light source configuration, or by removing the existing light source configuration and replacing it with a different light source configuration. It should be understood that any of the connection configurations described herein for the storage element can be adopted for the light source connection or coupling element, as appropriate for indicating to the driving or energizing system a characteristic of the light source, and that any of the connection configurations described herein for the light source can be adopted for the storage element connection or coupling element.

In another example of the lighting systems described herein (or as to any of the methods and apparatus described herein using connectors), the connector may be keyed, polarized or otherwise shaped or configured such that connection can be made with the lighting system in only a single configuration. Molex-type connectors can be suitable. This reduces the possibility of user error, and can also reduce the possibility of connecting storage elements to the circuit not designed for that circuit. Additionally, in any of the examples described herein where more than one connection is being made to the circuit, each connection can be configured so as to have a different shape, size or other aspect than each of the other connections so that a connector intended for one circuit location cannot be connected to a connector for any other circuit location. In examples described herein, suitable connectors include those that are mating or complementary and separable from each other, and may also include those that are pin and socket type, for example for lighting and driver applications. Suitable connectors may also be releasably latching, locking or otherwise engageable so they cannot be accidentally separated. The connectors can be any that do not require tools, can be manually manipulated, or that are structures that mate and are reusable.

A battery assembly is disclosed including at least one lithium-ion battery cell and a regulator circuit. The battery assembly is typically reliably encased in a secure housing or casing, typical for conventional rechargeable batteries. Contacts, connectors or other conductive elements are exposed or accessible from outside the housing so that the battery assembly can be incorporated into a recharging and/or power supply configuration. In one example, the battery assembly is configured to be incorporated in and operate with an emergency or lighting backup system, for example one that can be coupled to main power for recharging the battery assembly and also to a lighting array for providing illumination if the main power goes out, or decreases to a pre-selected voltage or power. In one example, the regulator circuit and battery cell are integral with each other inside the same housing or casing. In one example, the regulator circuit is formed from a plurality of analog components, and in another example, the regulator circuit effectively provides a constant current and constant voltage for the battery. In a further example, the regulator circuit is configured so that a charge current for the battery is less than 50% of the total current capacity of the battery, and in another example, is less than about 10% of the total capacity. In one design configuration, the regulator circuit is configured so that the charge current for the battery is about 5% of the total current capacity of the battery. In a further example, the regulator circuit includes a voltage detector and a switch, in one example a MOSFET. In another example, a plurality of battery cells form part of the battery assembly, and each battery cell includes a respective regulator circuit, and in one example, a respective voltage regulator and MOSFET.

In any of the examples described herein, including the examples described in the preceding paragraphs, the lighting system can be made part of or incorporated into an existing area lighting design or incorporated into a new area lighting design. It may be used in path and egress lighting arrangements, environmental lighting arrangements, common area lighting arrangements as well as many other applications. It may be incorporated into an existing lighting fixture configuration, or may be supported and installed separate from an existing lighting fixture configuration. The number, positioning and orientation of the supplemental lighting system may depend on lighting requirements, safety regulations, actual light output or battery size.

These and other examples are set forth more fully below in conjunction with drawings, a brief description of which follows.

### BRIEF DESCRIPTION OF THE DRAWINGS

FIG. 1 is a perspective view of an interior area of a building in the form of a hallway leading to an exit showing a lighting fixture and a control element in the form of wall switch assembly.

FIG. 2 is a transverse cross-section and partial schematic of the light fixture of FIG. 1 showing a conventional linear light fixture with a emergency lighting system incorporated therein.

FIG. 3 is a schematic showing a lighting circuit and a plurality of corresponding connection elements for use there with such as may be used with the emergency lighting system of FIG. 2.

FIG. 4 is a schematic and isometric view of a light assembly, in this example an LED array.

FIG. 5 is a schematic of a emergency lighting system in accordance with several examples described herein and that may be used with the lighting systems depicted in FIGS. 1-2.

FIG. 6 is an electrical schematic representing an example of a lighting circuit such as that depicted in FIG. 3 for use in the lighting systems depicted in FIGS. 1-2.

FIGS. 6A-6C are schematics of examples of battery assemblies for use with the lighting circuit of FIG. 6.

FIGS. 7A-7F are schematics of examples of battery assemblies for use with the lighting circuit of FIG. 6.

FIG. 8 is a schematic of a further example of a battery assembly for use with the lighting circuit of FIG. 6.

FIG. 9 is a schematic of a further example of a battery assembly for use with the lighting circuit of FIG. 6.

FIG. 10 is a schematic of a lighting system according to one example using a parallel array of light sources.

FIG. 11 is a schematic of a further lighting system according to one example using a series array of light sources.

FIG. 12 is a schematic of one example of a connection element for use with lighting systems described herein.

FIG. 13 is a schematic of a further lighting system according to one example using a series array of light sources operating at a constant power.

FIG. 14 is a schematic of a lighting system in accordance with several examples described herein and that may be used with a lighting system using LED light sources as the normal lighting source.

FIG. 15 is a schematic showing a lighting circuit and a plurality of corresponding connection elements for use there with, such as may be used with lighting systems described herein.

FIG. 16 is an electrical schematic representing a portion of one example of a lighting circuit such as that depicted in FIG. 14 for use with lighting systems described herein.

FIG. 17 is an electrical schematic representing another portion of one example of a lighting circuit such as that depicted in FIG. 14 to be used in combination with the portion shown in FIG. 16 for use with lighting systems described herein.

FIG. 18 is an electrical schematic representing a portion of the lighting circuit depicted in FIGS. 16-17 and representing a low voltage or emergency mode control circuit.

FIG. 19 is a schematic representation of an example of a light source and connector combination for use in indicating to a light source driver or energizing system characteristics of the light source.

FIG. 20 is a schematic block diagram of a lighting system in accordance with several examples described herein and that may be used with a lighting system using LED light sources as the normal lighting source and that may be used in a constant power output environment.

FIG. 21 is an electrical schematic of a battery assembly including a battery protection and/or control circuit.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of supplemental lighting systems and of methods of making and using the supplemental lighting systems are described. Depending on what feature or features are incorporated in a given structure or a given method, benefits can be achieved in the structure or the method. For example, supplemental lighting systems using LEDs may provide more flexibility in design and implementation and longer product lifetime. They may also permit better and more user friendly characteristics, for example fewer chances for error in installation and application. Supplemental lighting systems may have improved ease of and flexibility in installation.

Improvements are also provided to components that can be used with supplemental lighting systems. For example, supplemental lighting systems may include unique connectors that reduce the possibility of installation error, and they may also include elements to permit a variety of battery types or sizes to be used with the same charging and lighting circuit, or a variety of light source types or configurations to be used with the same driving or energizing circuit.

These and other benefits will become more apparent with consideration of the description of the examples herein. However, it should be understood that not all of the benefits or features discussed with respect to a particular example must be incorporated into a supplemental lighting system, component or method in order to achieve one or more benefits contemplated by these examples. Additionally, it should be understood that features of the examples can be incorporated into a supplemental lighting system, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of several supplemental lighting system configurations and of methods of making and using the supplemental lighting systems are described herein, along with components that can be used with such lighting systems, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results. For example, battery configuration identifiers or designators can be used in other applications. Also, light source configuration identifiers or designators can be used in other applications, as well. Additionally, a lithium ion battery and protection or regulator circuit can be used in applications other than emergency or supplemental lighting systems, lighting or otherwise.

LED light sources are used as examples of a source for a supplemental lighting system that can incorporate one or more of the features and derive some of the benefits described herein, and in particular emergency or backup lighting systems. However, other light sources can also be used in place of or in addition to LED light sources in the present apparatus and methods.

It should be understood that terminology used for orientation, such as front, rear, side, left and right, upper and lower, and the like, are used herein merely for ease of understanding and reference, and are not used as exclusive terms for the structures being described and illustrated. Additionally, the adjectives first, second, third, etc., are used to distinguish one element from another (such as an opening or contact identified or referenced first, second or third), and unless otherwise indicated, are not intended to define a particular position or location.

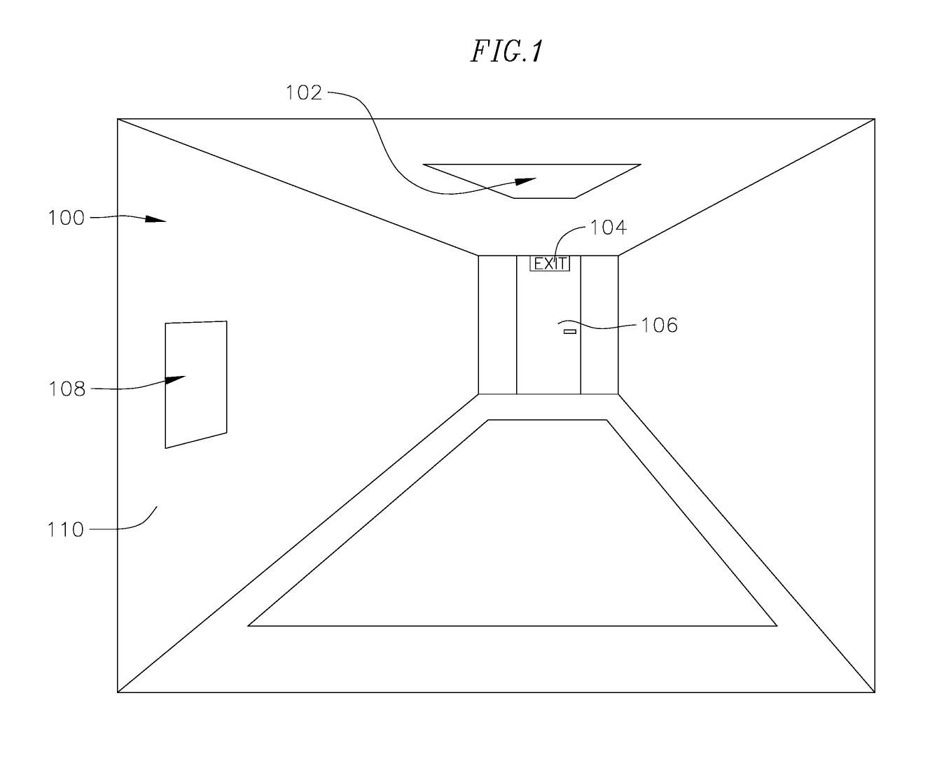

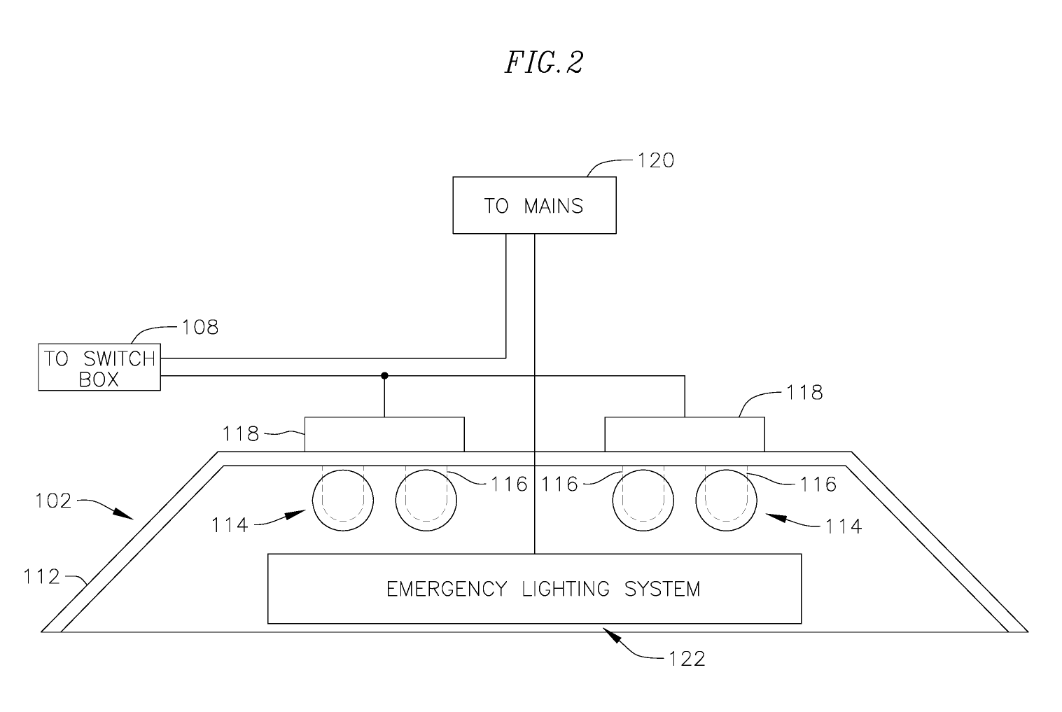

Supplemental lighting systems such as those described herein can be used in a number of applications. Examples of supplemental lighting systems include emergency lighting systems and backup lighting systems. They can be used to supplement existing or day-to-day path and egress lighting, area lighting, environmental lighting, workspace lighting as well as other applications. One application is illustrated in the context of area or common area lighting in FIGS. 1-2. As with any of the applications of the supplemental lighting system, the supplemental lighting system can be positioned and supported in an existing lighting fixture or separate and apart from existing lighting fixtures. In the present examples, the supplemental lighting system will be described in the context of mounting and support with an existing lighting fixture for use as an emergency lighting system, but it should be understood that the installations and applications to which the lighting system and any of its components can be applied extend beyond emergency applications.

Common areas such as common area 100 (FIG. 1) often use ceiling lighting 102 for day-to-day lighting. The ceiling lighting generally takes the form of one or more ceiling fixtures distributed about the area to be illuminated according to a selected lighting design. Only one ceiling fixture 102 is shown in FIG. 1. However, it should be understood that any number of ceiling fixtures will be used as desired, and each ceiling fixture can include a emergency lighting system, or an emergency lighting system can be supported elsewhere, for example one emergency lighting fixture for each ceiling fixture. Alternatively, the number of emergency lighting systems can be fewer than the number of ceiling lighting fixtures or greater than the number of ceiling lighting fixtures, either supported within the fixtures, outside the fixtures or both. The number, size, distribution and orientation of the emergency lighting systems will depend on the desired illumination for the area.

Signage can be provided, for example for emergency purposes, by an exit sign 104 at an exit 106 from the area. The exit sign 104, as is well known, provides illumination for the sign itself rather than area illumination.

The lights in the ceiling fixture 102 can be controlled by light switches or other controls in a control panel 108 on a wall 110 of the common area. Alternative controls include wall switches, circuit breakers, relays and other control mechanisms and systems. Alternatively, a control panel can be located in a separate area, such as an electrical room, control room or other remote area.

Considering the ceiling fixture 102 in more detail (FIG. 2), the ceiling fixture is a linear lamp fixture in a recessed housing 112. The housing supports a plurality of linear lamps 114, which, for example, may be fluorescent lamps or other common area light sources. The lamps are supported by and provided current through respective sockets 116, which in turn are electrically coupled to ballasts or other power supplies represented at 118. The ballasts may be contained in cans or other housings inside of a fixture housing, or they may be mounted directly to the side or surface of the fixture out of sight. The number of ballasts may vary according to the design of the fixture and the number of lamps. Each ballast is coupled to a main power supply such as the Main building panel 120, and the ballasts are controlled by the switches or other controls, for example in the control panel or switchbox 108. Other existing lighting systems with which the examples can be used include compact light sources, incandescents, halogen light sources, as well as others.

In the present example, an emergency lighting system 122 has a configuration in terms of size and orientation that allows it to be supported by and secured in the ceiling fixture 102. The emergency lighting system 122 is shown schematically in FIG. 2. Depending on its size and orientation, the emergency lighting system can be placed on any available surface in the ceiling fixture 102. In the present examples, the emergency lighting system is provided power only through the main service panel 120, and is not controlled by any control switches or other controls such as human or automated controls. In other applications, an emergency lighting system can be connected and operated through control equipment.

The emergency lighting system 122 shown in FIG. 2 is shown schematically as a single component. In one example, the emergency lighting system can be a series of components mounted in and supported by a single housing, with appropriate conductors going to the mains supply panel. The light source can be mounted to the housing or supported inside the housing while allowing light to pass through a housing wall, such as a clear plastic wall or the like. A lighting electronic circuit and an electronic storage device can be mounted in and supported by the housing and coupled to the light source for providing current to the light source.

In another example, the emergency lighting system can be formed from a number of discrete components, each supported by a single housing or each supported separately, for example in the ceiling light fixture 102. In the following discussion, the examples will have a emergency lighting system composed of two or more individual components.

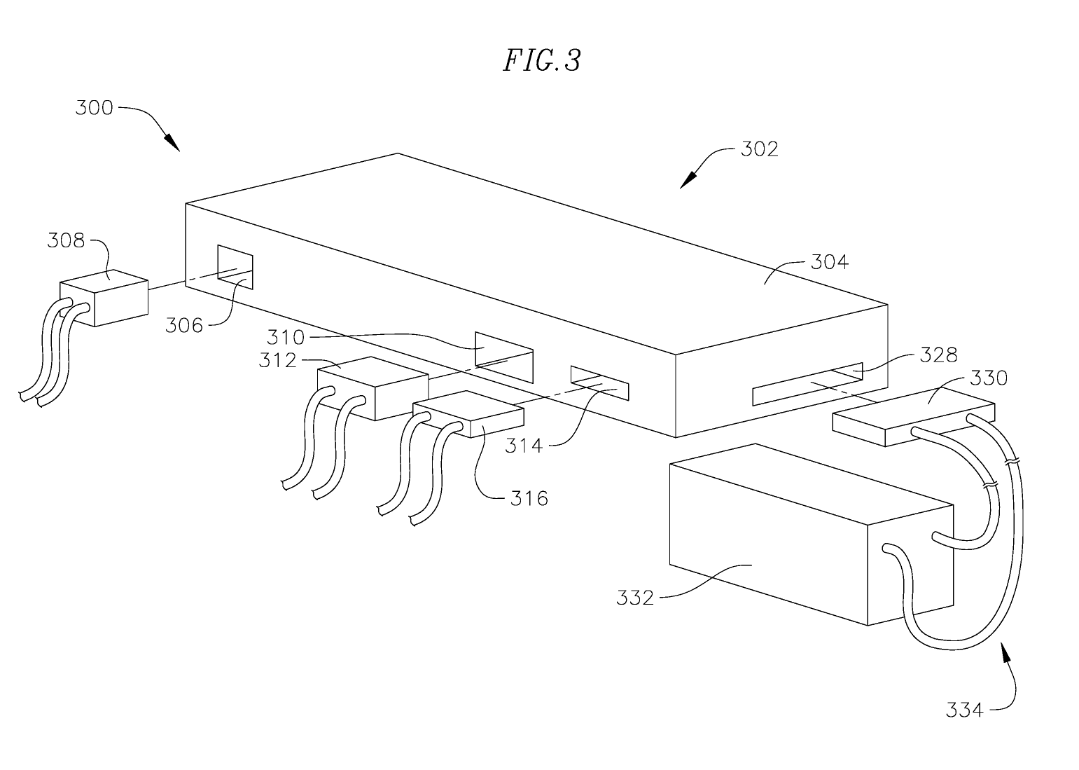

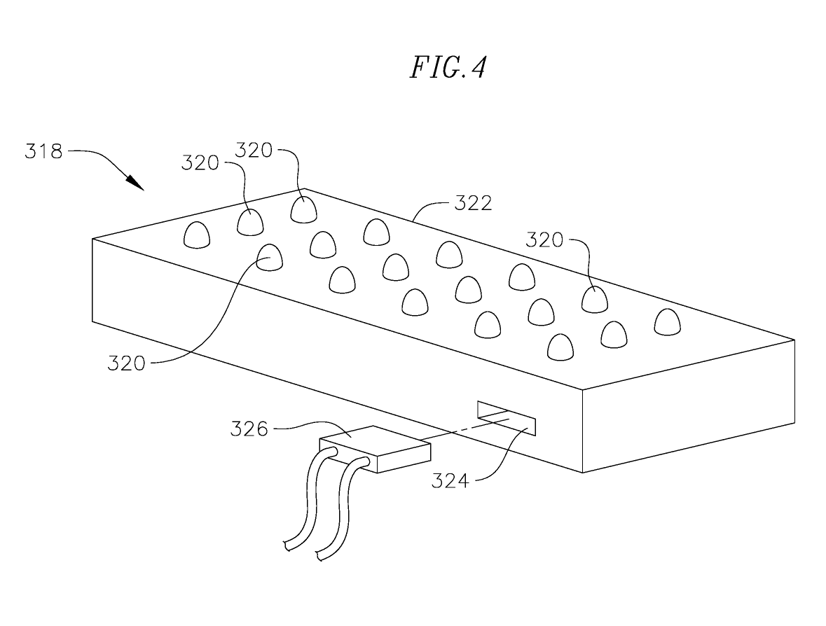

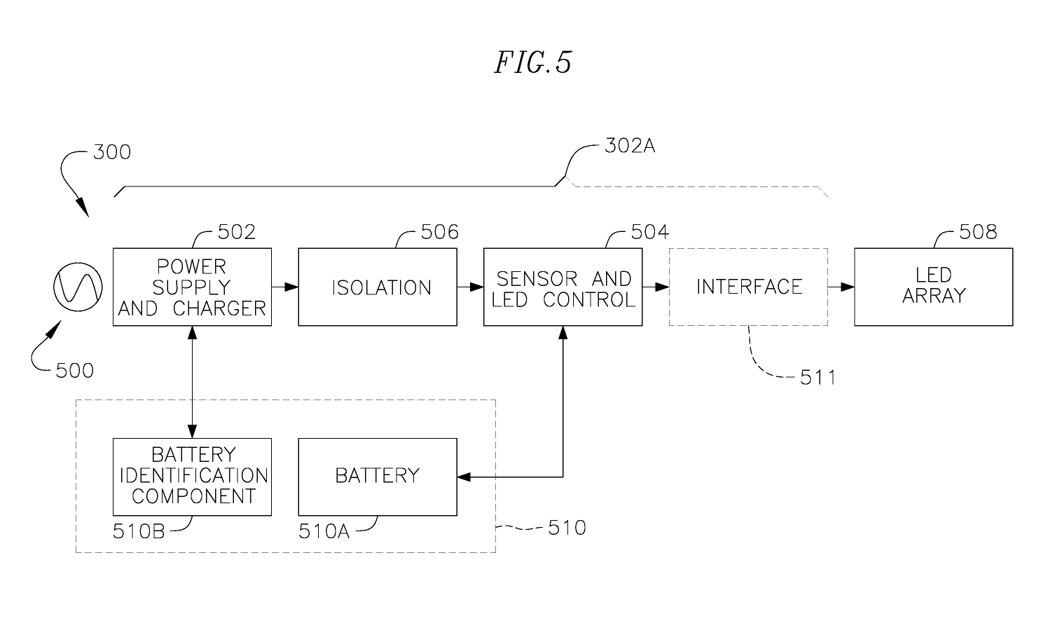

In one example of an emergency lighting system (FIGS. 3-4), a lighting system 300 and electrical circuit assembly 302 are contained in and supported by a housing 304. The electrical circuit is described more fully below in conjunction with FIGS. 5 and 6. In the present example, the housing wall includes a number of openings in which are mounted respective sockets for receiving respective connectors. In the present example, each of the openings and their respective sockets in the housing 304 are distinct and different from each of the others. Having different sized openings and sockets minimize the possibility of erroneous connections of components. Additionally in the present example, each of the sockets and the corresponding connectors are keyed, polarized or otherwise shaped so as to permit complete connection only in a single orientation. Keying or polarization also helps to reduce the possibility of erroneous connections. An example of a polarized connector is shown in FIG. 12. Also in the present example, a first opening provides access to a power supply socket 306 for receiving a power supply connector 308. The power supply connector 308 in the present example is coupled directly to the main power panel. The socket 306 and the connector 308 are configured so as to easily accommodate the voltages and current expected to be applied to the emergency lighting system.

Lighting system 300 also includes an opening for providing access to a test socket 310 supported in the housing 304 for a test and status connector 312. The test and status connector can be used to connect to the electrical circuit assembly 302 a test switch, such as a manual pushbutton switch (not shown) through a respective pair of conductors. The test and status connector can also be used at the same time to connect a status indicator, such as a status LED (not shown) through its own respective pair of conductors. While only two conductors are shown for the connector 312, it will be understood that the two conductors represent the number of conductors selected for the particular application, in this case for the test switch and the status indicator. The test switch can be used to indicate that the emergency lighting system is operating normally, and will also operate normally when needed, such as during a power outage or low-power condition.

The lighting system 300 also includes an opening for providing access to a light socket 314 supported in the housing 304. The light socket 314 is configured to receive and support a light connector 316, which in turn is connected to a light source 318 (FIG. 4), which also forms part of the emergency lighting system 300 even though it is shown on a separate sheet from FIG. 3. In the present example, the light source 318 is formed from an array of parallel-connected LEDs 320 arranged on and supported by a light housing 322. The LEDs are arranged in a planar array on the surface of the housing 322 in a uniform pattern. Alternatively, they can be arranged on multiple surfaces, on a single non-planar surface, oriented in different directions, or otherwise arranged. They can also include lenses, reflectors, and other optical elements desired for the particular result and application for which the system is intended. Additionally, the light source can be a single LED, or the light source can be other light producing elements or components arranged as described for the LEDs or otherwise suitable for the particular light producing element or component. The configuration of the light producing element or component may depend on the desired light output, the available power supply, as well as the light producing capability of the light producing element or component itself. The configuration may also depend on the available space as well as other factors of the particular area to be illuminated.

While the light source 318 can be directly hardwired to its connector 316, the light source 318 of the present example includes an opening for providing access to a lighting circuit connection socket 324 for receiving a lighting circuit connector 326 which could be hardwired or otherwise coupled to the socket 316. The connector assembly of the connector 316 and the connector 326 and their associated conductors can be configured to have the desired length for the particular design. In the present example, the connector 326 is distinct and different from each of the other connectors in the lighting system 300.

The lighting system 300 further includes an opening for providing access to a battery socket 328 (FIG. 3) supported in housing 304. The battery socket 328 is configured to receive and support a battery connector 330, which in turn is electrically connected to an energy storage device, for example in the form of storage battery 332. The connector 330 and the storage battery 332 form a battery assembly 334 for supplying energy to the electrical lighting circuit 302 through the connector 330. It should be understood that while components 328 and 330 are sometimes referred to herein as socket and plug, respectively, they can take a number of forms of complimentary engaging components, whether plug and socket, respectively or other configurations. In the examples considered herein, the storage battery 332 is a rechargeable battery. The battery is recharged also through the electrical lighting circuit 302, as described more fully below. In the present examples, the rechargeable battery can take any number of configurations rechargeable through the electric lighting circuit 302 and that can provide power to light sources, such as the light source 318. Integration of the rechargeable battery assembly into the electric lighting circuit is described more fully below, along with various forms of connection of the battery assembly.

The battery connector 330, as with any of the connectors herein, can though need not be configured to be unique relative to the other connectors. Being unique reduces the likelihood of mis-connections. Additionally, the battery connector 330 is keyed, polarized or otherwise configured to permit connection with the socket 328 in only one orientation. Additional configuration information about the battery socket 330 is described more fully below.

In another example of the lighting circuit 300, any or all of the sockets 306, 310, 314 and 328 can be formed as mating connectors for their respective connectors coupled to the electrical lighting circuit 302 through connectors passing through the housing 304. As such, the mating connectors can take any number of configurations suitable for reliable electrical connection with their respective connectors, and need not be sockets specifically. Mating connectors coupled to the housing through respective wires or other conductors provide additional flexibility in positioning the various wires and mating connections.

In a combination of components described with respect to FIGS. 3 and 4, a lighting system can be configured to form part of or incorporated into an existing area lighting design or incorporated into a new lighting design. The assembly may be used in path and egress lighting arrangements, environmental lighting arrangements, common area lighting arrangements as well as many other applications. It may be incorporated into an existing lighting fixture configuration such as that described with respect to FIGS. 1 and 2, or may be supported and installed separate from an existing lighting fixture configuration. The number, positioning and orientation of an emergency lighting system such as that described may depend on lighting requirements, regulations and rated light output and battery size, as well as other considerations.

The lighting system 300 and its electrical circuit assembly 302 can take a number of configurations. In the example shown in FIG. 5, the lighting system receives power during normal operating conditions from a power source 500, such as from the main service panel. The power may be in the form of typical voltages and currents, and may range from 110-240 VAC alternating current or 110-277 VAC, for example, and may range from 47-63 Hz, for example. The power is received through the power supply connector 308 at a primary circuit in the form of power supply and charger circuit 502 in the electrical circuit assembly 302. The power supply and charger circuit 502 is coupled to a secondary circuit in the form of a sensor and LED control circuit 504 through an isolation circuit 506. An LED array 508, such as the light source 318 shown in FIG. 4, is coupled to the sensor and LED control circuit 504 for receiving current to power the LED array.

An assembly 510 including an electrical storage element such as a battery 510A is coupled to the sensor and LED control circuit 504 on the side opposite of the isolation circuit 506 from the power supply and charger circuit 502. Battery discharge occurs to the sensor and LED control circuit 504. In the present configuration, the battery 510 is a rechargeable battery assembly. In this configuration, the battery is also charged through the sensor and LED control circuit 504. The assembly 510 also includes a battery identification component 510B. The battery identification component 510B includes a hardware, firmware or software component that signifies, for example to the lighting circuit, the battery configuration. A typical configuration to be presented to the lighting circuit may be the battery capacity. Other details may also be presented. The mode of presentation may be selected as desired, and includes one or more of the modes described herein. When the assembly 510 is joined to the lighting circuit, the lighting circuit knows the battery configuration and the battery can be discharged and/or charged accordingly. Other actions can be taken as well, for example lighting indicator lights, sending signals to external devices, as well as other actions.

The lighting system 300 may also include other components, as desired, such as the interface 511 represented by the dashed-line box in FIG. 5. The interface may be included, for example, to accommodate alternative light sources, such as an alternative LED array.

In the present example, the power supply and charger circuit 502 receives current at the line voltage and drives the secondary circuit through the isolation circuit for charging the battery 510. An alternating current is induced in the secondary circuit sensor and LED control 504 through the isolation circuit 506. The sensor and LED control circuit 504 senses the alternating current and does not conduct current to the light source so that the light source such as LED array 508 is not illuminated. If the sensor and LED control circuit 504 senses that the alternating current drops below a threshold value, the sensor and LED control circuit 504 draws current from the battery assembly 510 and turns on a current control device to drive the LED array 508. The threshold value in the present configurations is at or near the equivalent of a power outage. However, it should be understood that threshold setting circuits can also be included if desired.

In the present examples, the isolation circuit 506 takes the form of a transformer, such as that described in FIG. 6 configured in the present examples to be inverting. Where the light source 508 is an LED array or other low-voltage light source, the isolation circuit 506 isolates the primary and secondary circuits and helps to protect the sensor and LED control circuit 504 and the LED array 508 from the high voltage and current in the primary circuit of the power supply and charger circuit 502. Other isolation configurations can be used, including capacitive isolation.

The power supply and charger circuit 502 in the present examples includes a Universal charger for the battery assembly 510. The universal charger accepts incoming AC voltages at a number of different levels, for example between 110 VAC and 277 VAC, as well as differing frequencies such as between 47-63 Hz. The charger can also be used to charge a number of different-sized batteries, which allows a number of different battery configurations to be used with a single electrical lighting circuit.

The battery assembly 510 in the present examples includes a connector configuration complementary to a mating connector configuration in the electrical lighting circuit 302. The mating connector configuration and the lighting circuit 302 are configured so that batteries having different capacity ratings can be connected to the same circuit 302, and in the described examples the connection can be made without having to reconfigure any wiring, connections or other components to accommodate the different batteries. Batteries having different rating configurations can be charged equally well with the electrical lighting circuit 302 simply by establishing the mating connection between the battery assembly 510 and the electrical lighting circuit 302.

With the battery assembly 510 coupled to the sensor and LED control circuit 504, the rechargeable battery can be charged from power provided through the power supply and charger circuit 502. Additionally, the battery can be used to supply current to the sensor and LED control circuit 504 in the secondary circuit for powering the LED array 508, particularly when the LED array 508 is a low-voltage device or assembly.

In the present example, the electronic lighting circuit 302 (FIG. 6) includes the power supply and charger 502 in the primary circuit and the sensor and LED control 504 in the secondary circuit. The isolation circuit 506 couples the primary and secondary circuits together. Considering the circuit 302 in more detail, the primary circuit is a flyback circuit for providing low voltage DC output to the secondary circuit and receives power from the main power supply connector 306. The primary circuit receives power through a conventional fuse 602. A transient voltage suppressor 604 is connected across the line where the AC is input to a rectifier circuit 606. The rectified AC is applied to a smoothing circuit having a pair of parallel-connected electrolytic capacitors 608 and 610, the positive side of each of which are coupled on respective sides of an inductor 612 for filtering EMI. The inductor 612 is coupled to the Vext of a constant voltage/constant current switching circuit 614. In the present example, the switching circuit 614 is a Linkswitch LNK 501 switching circuit, the February 2005 specification sheet of which is incorporated herein by reference. A clamp diode 616, resistor 618 and clamp capacitor 620 are coupled to the switching circuit in the conventional manner. A control pin capacitor 622 is coupled in the conventional manner between the control pin or Vref and the switching circuit output.

In the present example, a plurality of resistors 624 are coupled between the control pin and respective contacts or pins in the battery socket 328. In the present example, a separate resistor is provided for each battery Capacity configuration expected to be coupled to the lighting circuit. Having separate and different resistors coupled between the switching circuit 614 and separate, respective contacts or pins in the battery socket 328 allows the battery socket 328 to set the charging current and to receive and charge at least a like number of different battery configurations (and possibly more depending on the configuration), for example batteries of different capacities, alternatively connected in the same battery socket. The electrical lighting circuit and the socket 328 do not have to be rewired or otherwise reconfigured to accept different types of batteries. In one example, if the lighting circuit 302 was intended to accept only two different types of batteries, two different resistors 624 can be coupled to respective separate contacts in the socket 328 and the socket can receive the two different batteries, for example for charging. In another example, if the lighting circuit 302 was intended to accept only three different types of batteries, three different resistors 624, for example the three different resistors R9 (626), R11 (628), and R12 (630), can be coupled to respective separate contacts in the socket 328, corresponding to pins 3, 2 and 4, respectively. In other examples, four or more different resistors may be included along with a corresponding number of separate and individual contacts in the socket 328.

Other circuit configurations than separate and individual resistors can also be used to accomplish the same or similar result. For example, a first resistor (such as R11) can be selected and connected to Vref, between Vref and each of R9 and R12. The two additional resistors R9 and R12 would be configured to provide effectively the same result as R9, R11 and R12 in FIG. 6. One lead for the pins 2-4 in the connector 328, for example from pin 2, would be connected only to the first resistor, and the other leads for pins 3 and 4 would be connected to the first resistor through respective resistors (for example R9 and R12). Therefore, the voltage setting corresponding to pin 2 is set by R11, pin 3 by R9 plus R11, and pin 4 by R12 plus R11. Such a series arrangement of resistances is easy to calculate to produce the desired voltages at Vref. Parallel resistors can also be configured for the same purpose, as can a combination of series and parallel resistors. It is noted that use of two resistors in series to set respective voltages at Vref and then using the same resistors in parallel to set a third voltage at Vref allows the slot for a pin corresponding to a third resistor to be used for other purposes or eliminated entirely. Alternative to resistances, other circuit configurations can be used to alternately select or identify the settings to be used for different battery configurations using the connection of socket 328 and plug 330.

The power supply and charger circuit 502 also includes a tap between the clamp diode 616 and the clamp capacitor 620 leading to a separate contact, in the present example pin 1, in the socket 328. In the present example of the power supply and charger circuit 502 shown in FIG. 6, the reference charging current for the battery is determined by one of the resistors 626, 628 and 630, by a jumper or other coupling of pin 1 with the pin or contact corresponding to one of the resistors 626, 628 and 630.

In the context of a connector 330 configured for connecting to the socket in an electrical lighting circuit, such as those described herein, the connector 330 includes one active contact in a position corresponding to pin 1 of the socket 328 and one active contact in a position corresponding to only one reference capacity. Additional active contacts, described more fully below, are provided in the connector 330 for the sensor and LED control circuit 504 for charging and discharging the battery and for operating the circuit. Further active contacts may also be provided in the connector, if desired, for example for redundant connections or communication with the battery such as for SMBus controller inside the battery pack or for other uses, but additional active contacts are not needed to be included for the power supply and charger circuit 502 for complete identification of the battery configuration. In the present examples, “active contact” refers to a normally functioning contact or pin in a connector (for example a socket, plug, or other means for selectively establishing an electrical connection) that is connected for functioning in its intended mode. For example, in the connector 330, an active contact would be one that would be electrically connected to a jumper between the two contacts, for example those corresponding to pin 1 and the pin for the appropriate resistor. While the connector 330 may also include contacts in respective slots, openings or other positions in the connector for making contact with a contact in a socket or other component, the contact would not be active if it was not operationally coupled to any other component leading out of the device, for example connector 330, for example to a reference resistor. Additionally, for a slot that completely omitted a contact, so that not only is there no active contact but no contact at all, the slot could serve the same purpose as an inactive contact. For example, for an empty slot, the slot would serve as part of a connector configuration that would join some but not all possible candidate connectors to form a working connection. An example of a socket with contacts in respective slots and also an empty slot is shown in FIG. 12.

In the present example of the apparatus shown in FIGS. 6 and 6A, the connector 330A would have active contacts in positions corresponding to pin 1 of the socket 328 and one of pins 2, 3 and 4 by way of a jumper 632 connecting the two contacts. In the example shown in FIG. 6A, the jumper 632 connects the contacts associated with pins 1 and 4, thereby making them active contacts because they would function in their intended way when connection(s) are completed to other components. The connector 330A would also have active contacts for the sensor and LED control circuit 504, as discussed more fully below.

Examples of alternatives to the connector configuration shown in FIG. 6A, such as for alternate battery configurations, include a connector 330B with a jumper 632B coupling pins 1 and 3 together (FIG. 6B). A battery with a second capacity, for example different from the battery incorporating the connector 330A, is assembled with the connector 330B. When the battery assembly is coupled into the lighting system, the common of the lighting circuit is coupled to Vref through resistor R9 to set a reference voltage different from that for the battery 332. A third configuration includes connector 330C with a jumper 632C coupling pins 1 and 2 together (FIG. 6C) for identifying a third battery configuration, for example having a third battery capacity. When the battery assembly is coupled to the lighting circuit, the connector 330C couples the common of the lighting circuit through resistor R11 to Vref, thereby setting the reference voltage for charging a third battery configuration. If the system was designed to accommodate additional batteries, additional resistor configurations and corresponding slots, if desired, can be included, which possibility is represented by the dashed line for the jumper 632C.

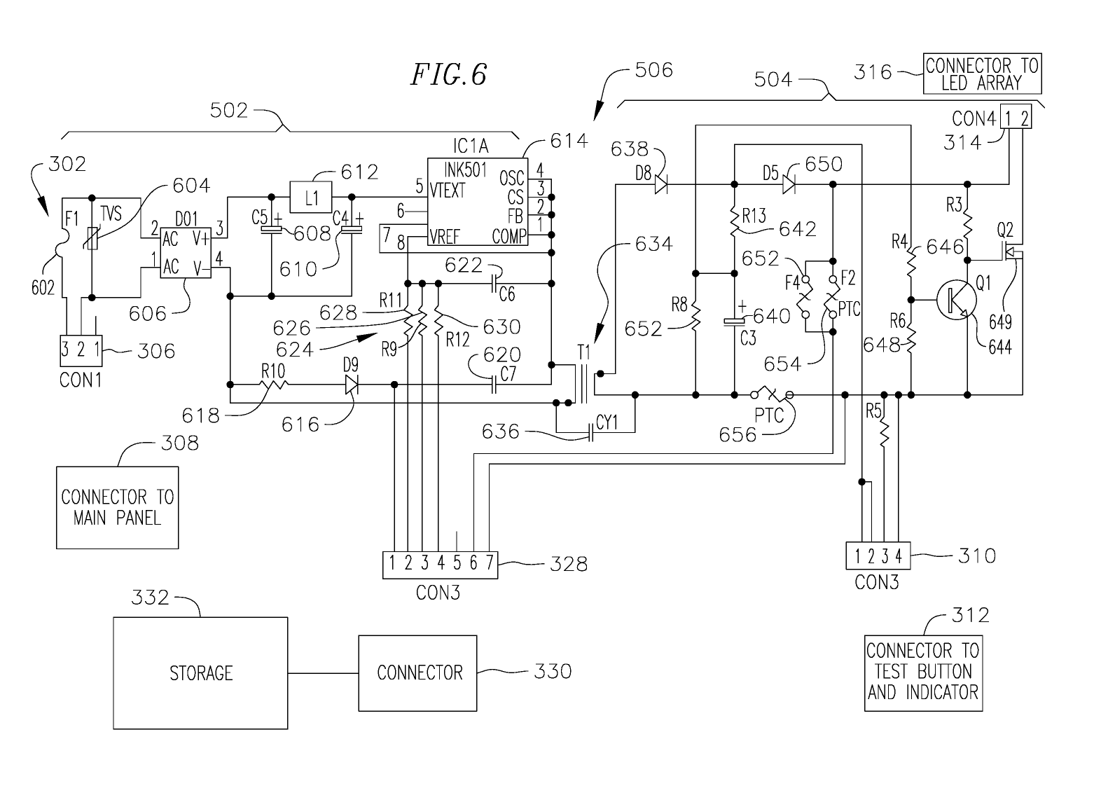

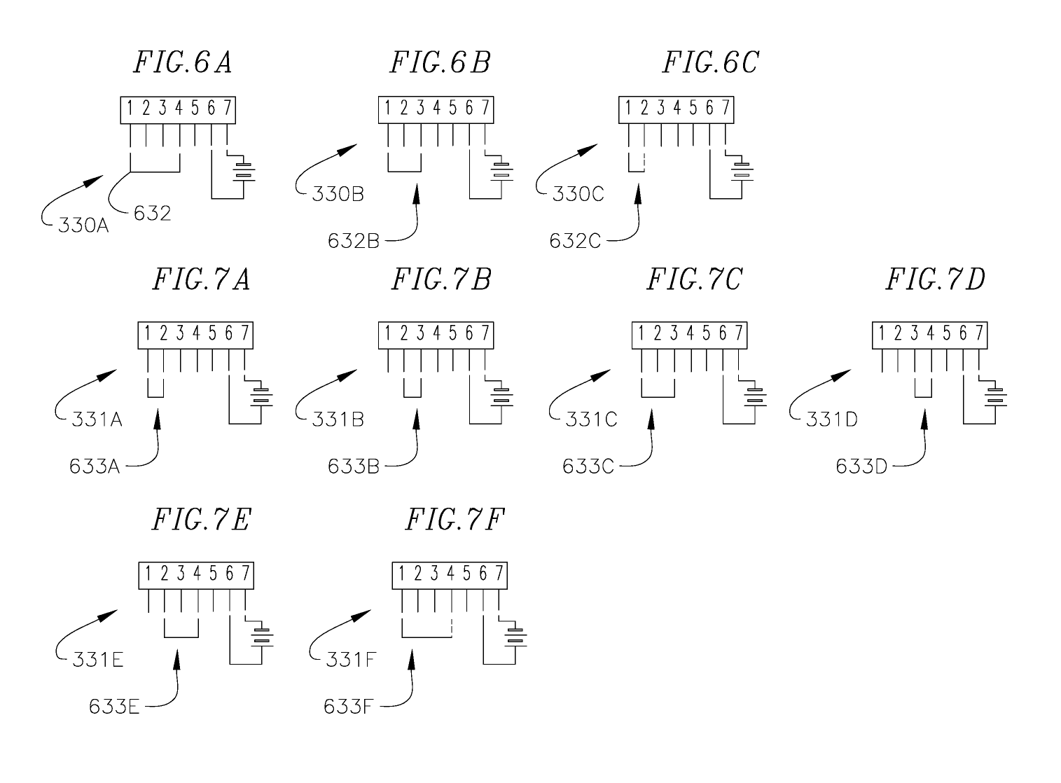

The lighting circuit and its battery assembly shown in FIG. 6 uses a configuration whereby the common of the lighting circuit is always at pin 1 of the connector, and the other slots are selected as a function of the desired Vref value. In other possible configurations of lighting system, settings or other circuit configurations can be selected or set with a connector such as battery assembly connector, for example, by having a jumper span any two or more contacts in the connector, thereby forming a circuit connection in the lighting system when the connector is connected to the lighting circuit. For example, one configuration has a jumper 633A spanning pins 1 and 2 of a connector 331A (FIG. 7A). In another example, a jumper 633B spans pins 2 and 3 of a connector 331B (FIG. 7B). Further examples have a jumper 633C spanning pins 1 and 3 (FIG. 7C), and a jumper 633D spanning pins 3 and 4 (FIG. 7D). Still further examples have a jumper 633E spanning pins 2 and 4 (FIG. 7E) and a jumper 633F spanning pins 1 and 4 (FIG. 7F). With additional slots, additional contacts can accommodate additional combinations of jumpers/connections, as desired, which possibility is represented by the dashed line for the jumper 633F. Alternatively, even without additional slots, jumpers can span more than two pins to form other combinations of connections, as desired. Additionally, with the foregoing possible connection configurations, the lighting circuit can be configured to use the selections specified by the battery assembly connector in a number of ways. For example, an assembly of resistors, configured in ways such as described herein, can be used to set the lighting circuit for the battery configuration with which the connector is used. In other examples, one or more integrated circuits can interpret and make the settings identified by the battery connector.

A further example of a battery configuration identifier or designator includes a connector 331G (FIG. 8) for a battery with a plurality of slots. At least some of the slots have respective contacts for connecting with associated contacts in a lighting circuit connector. In the present example, a simple implementation with a small number of slots and contacts includes battery charging and discharging contacts 331G′ and designator contacts 331G″ for identifying the battery information. In the present examples, the designator contacts 331G″ are substantially identical as between different battery configurations (at least as the designator contacts are concerned). However, they need not be substantially identical if desired. The connector includes a jumper having a designator corresponding to a respective battery configuration for each different battery. In the present examples, the designator is a resistor 331G′″ selected to have a value for setting the desired Vref in the lighting circuit of FIG. 6. Therefore, the value, Rn, of the resistor 331G′″ will be different for each Vref value to be set. Generally, each battery capacity will have a corresponding Vref to be selected. Any given battery assembly will then have a resistor and jumper combination suitable for the battery that then sets the Vref once the connector 331G is connected to the lighting circuit. The number “n” in Rn will be between 1 and the maximum number of battery configurations for which the lighting circuit is designed. The resistors R9, R11, and R12 shown in FIG. 6 can then be omitted, as the Vref is set by the resistance in the battery assembly connector, unless a resistance is desirable in the charging circuit for reducing power dissipation when the LEDs are not illuminated or for other reasons.

In another example of a battery configuration identifier or designator, a connector 331H (FIG. 9) for a battery may include a plurality of slots wherein at least some of the slots have respective contacts for connecting with associated contacts in a lighting circuit connector. In the connector 331H, the battery is connected for charging and discharging in a desired configuration, such as at contacts 331H′. In the present example, the battery assembly includes a device 331H″, such as an integrated circuit, for providing more detailed information from the battery assembly to the lighting circuit. The device 331H″ is coupled into the connector 331H over an SMBCLK line and an SMBDAT line, each biased at +5 volts. Such hardware uses software suitable for the information transfer and recording, and may use known SMBus technology and protocols or other standards for the desired operation. In one example, the integrated circuit may include one or more memory devices containing information stored thereon about the battery and its operating characteristics. For example, the information may include battery type, capacity, and charging voltage and current, as well as other useful information such as manufacturer, manufacture date, and the like. Once the battery assembly is connected, the lighting circuit and battery assembly communicate with each other so that the lighting circuit can be set as desired. The combination of the lighting circuit and battery assembly can also indicate battery status, for example, expected remaining life, as well as other information. In the lighting circuit, the resistors R9, R11, and R12 shown in FIG. 6 can then be omitted, as the Vref is set by the information through the battery assembly connector, unless a resistance is desired in the charging circuit for reducing power dissipation when the LEDs are not illuminated.

The foregoing examples of apparatus and methods for identifying, designating or signaling to a lighting circuit the particular battery configuration being connected to it can be used with a number of battery types. For example, NiCad or metal hydride batteries may incorporate a connection configuration allowing them to be used with constant current charging systems in the lighting system, and may include a configuration for designating to the lighting circuit the battery characteristics. For NiCad or metal hydride batteries, for example, the designation may correspond to the battery capacity, to permit the charging system to properly charge the battery. In another example, lithium ion batteries may incorporate a connection configuration allowing them to be used in a lighting system having a different charging configuration. For lithium-ion batteries, for example, the designation may correspond to the battery type and capacity so that the charging system can charge at the proper voltage and current for the battery.

In other configurations of lighting circuits and battery configurations, the respective connections in the lighting circuit and the battery may prevent even a physical connection where the lighting system is designed for a NiCad or metal hydride battery but the battery is a lithium-ion, or vice versa. Alternatively, the respective connections in the lighting circuit and the battery may permit physical connection of the connector elements even though active contact elements in the lighting circuit do not match up with active contact elements in the battery, thereby still preventing operation of the battery with the lighting circuit. In a further alternative, some active contact elements may make contact while at least one active contact element is missing a mating connection. For example in a lighting circuit accommodating NiCad or metal hydride batteries, the connections may be configured so that no active contact elements or less than all are joined between the lighting circuit and a lithium ion battery/connector combination. Similarly, a lighting circuit operating along with a lithium-ion battery may be configured so that no active contact elements or less than all are joined between the lighting circuit and NiCad or metal hydride batteries. In other examples, battery designations or identifications can be made digitally or through other communications methods such as SM bus technology. In the example of SM bus technology, additional information can be provided to the lighting circuit, such as remaining battery life, signals for setting visible indicators or for sending information to remote locations, or the like. Other active approaches can be used to indicate configurations to the system, including pulse width modulation techniques, ascii coded information, and even applications that would use a single wire or single conductor connection for the indicating function. Therefore, battery chemistries (NiCad or metal hydride batteries versus lithium ion batteries) can be used as a determinant for configuring the connections; additionally, for a given battery chemistry, the connections can then be configured for battery capacities or other battery characteristics. In any case, the ability of a lighting system to accommodate and operate with batteries of different configurations provides flexibility in design and operation. Therefore, with a suitable lighting circuit, different battery and connector configurations can be combined with the lighting circuit as desired, with the battery and connector configuration indicating to the lighting circuit the necessary battery characteristics for proper operation.

As discussed herein, the socket 328 and the connector 330 and 330A in the present example are keyed, polarized or otherwise oriented so that the socket and connector can be joined in only one configuration. FIG. 12 shows a polarized connector 330J with an asymmetric surface 700 to provide one form of keying or polarization. Other forms of polarization can be used instead or in addition, for example by changing an opening, closing an opening or otherwise changing the connector to form an asymmetry. Polarization reduces the possibility that an unintended connection is made between the battery and the power supply and charger circuit 502. It also makes it easier for installation personnel to make the connection according to the intended design.

The connector 331J also includes openings 706 within a body 708. In the present example, five openings 706 are formed in the body. These five openings will join comparable structures in a lighting circuit socket. Comments regarding polarization, openings and contact elements may apply as well to lighting circuit socket structures for connection elements intended to be used together. However, the present description of the connector 331J will be made in the context of its use in a battery assembly with the understanding that a complimentary structure is contemplated for the lighting circuit connection, though the structures can be transposed.

The connector 331J can be a structure suitable for use in the configurations of the connectors 331G or 331H. The connector 331J can include active contact elements 701, 702, 703 and 704 corresponding to the pins 1-4, respectively in the connectors 331G and 331H. The contact elements can be any form suitable for establishing the desired electrical connection, and in the example shown in FIG. 12 are cylindrical contact elements. Contact elements 701 and 702 couple with the mating connection on the lighting circuit for indicating to or setting the lighting circuit for the battery connected to it. Contact elements 703 and 704 connect the battery itself to the lighting circuit, and the empty slot between them can serve a number of functions. For example the empty slot may provide an insulating barrier between them, or the empty slot may provide a keying or polarizing function when used in conjunction with another structure in the corresponding position in the opposite connection element. In another configuration, the slot between the contact elements 703 and 704 can include a contact element that is either inactive or active for a desired purpose.

In the present example, the resistors 624 set the charge current, and the particular resistor for setting the charge current is selected as a function of the configuration of the connector 330. The selected resistor can be chosen in other ways, as well. For example, the jumper 632 can be set in other ways, for example through a separate connector physically separate from the connector 330A. In another example, a separate connector can be secured to the battery assembly with the jumper and the battery connections being made when the battery is installed. The separate connector can be secured to the battery for example by a pigtail, cord or other flexible securement, or by other means. In the present examples, the appropriate jumper and battery electrical connector are combined into the same physical connector 330 housing so that setting the jumper and connecting the battery can be accomplished in a single operation. Additionally, a single physical connector 330 allows polarization or keying to be applied to a single structure.

Other ways for selecting the appropriate reference voltage for the charging circuit may also be used. For example, switches could be used to select one or more resistors for setting the appropriate reference voltage. Manual switches can be included on a circuit board, extending out through any circuit housing, switches could be set at the factory so the circuit 302 properly accommodates only a single battery type, or could be user selectable. While jumpers used in the connector 330A allow selection of the reference voltage to be specifically tied to the battery storage device to which the connector 330A is physically connected, jumpers instead can be used on the circuit board or in other locations as desired. In another configuration, traces on the circuit board can be removed or otherwise opened leaving only the selected resistance for the reference voltage corresponding to the battery size to be used with the lighting circuit 302. An adjustable resistor can also be used, and adjusted as a function of the particular battery configuration to be used with the circuit at the time. Alternatively, a single reference voltage can be defined by using only a single resistor whose value is chosen for a single selected battery configuration intended to be used with the system, as noted with respect to the example described with respect to FIG. 8.

The isolation circuit 506 in the present example takes the form of a transformer 634, in this example wired for inverting the current from the power supply and charger circuit 502. Other forms of the isolation between the primary and secondary circuits are also possible.

A high frequency filtering capacitor 636 is coupled across the transformer 634. The capacitor 636 filters electro-magnetic interference.

The sensor and LED control circuit 504 connects to the secondary for the transformer 634. The sensor and LED control circuit senses the existence of power from the main power connector 306 and keeps current from the LED array while power is at the desired level. If the main power supply drops below a nominal level, the sensor and LED control circuit 504 supplies current to the LED array from the battery for the lifetime of the battery or until the main power supply rises again.

The sensor and LED control circuit includes a diode 638 to rectify the AC output from the secondary of the transformer 634. The diode 638 provides direct current to the rest of the sensor and LED control circuit for charging the battery 332 and operating the rest of the secondary. The output of the diode 638 is coupled to an electrolytic capacitor 640 through a ripple current limiting resistor 642. When the capacitor 640 is charged, it provides a clean DC voltage to the base of a transistor 644 through a voltage divider set of resistors 646 and 648. The voltage on the capacitor 640 is applied to the base of transistor 644 to pull the gate of MOSFET 649 to ground, thereby turning off the MOSFET. The MOSFET 649 is coupled to one pin of the light source socket 314, the other pin of which is coupled to the output of diode 638 through diode 650, which blocks voltage from the battery from providing a voltage to the base of transistor 644. When the MOSFET is turned off, the LED array is not illuminated. However, when power is lost from the main power supply connector 306, the voltage on capacitor 640 drains through resistor 652 and the voltage is no longer maintained on the base of transistor 644. The gate of the MOSFET 649 will no longer be at ground, and the MOSFET will begin to conduct, thereby providing current to the LED array by the pullup resistor R3, which pulls the MOSFET gate up to Vbatt, thereby turning it on. Therefore, in the event of a power failure, transistor 644 cannot pull the gate of MOSFET 649 to ground, allowing voltage at the gate of the MOSFET. The MOSFET then turns on to supply current to the light source.

The output of the diode 650 is coupled through a pair of parallel connected positive thermal coefficient devices 652 and 654 to one contact or pin in the battery socket 328. In the present example, the output is coupled to pin 6 of the connector, which corresponds to and connects with pin 6 in the connector 330A (FIG. 6A). The other pin 7 of the battery connector 330A is connected back through the socket 328 to pin 7 to the MOSFET 649. When the MOSFET turns on, the battery supplies current to the LED array. Another positive temperature coefficient device 656 is coupled between the MOSFET and the transformer 634. The positive temperature coefficient devices 652 and 654 provide high current protection to the load, preventing it from exceeding 6 amps. The device 656 provides protection to the circuit if the battery is connected backward.

Pins 1 and 4 on the test button and indicator socket 310 connect to the test switch to simulate the loss of voltage. Pins 2 and 3 provide current to the status indicator. In another alternative, the socket 310 can be a two-pin connector, with the lines for pins 2 and 3 eliminated and the resistance corresponding to R5 placed in series with the indicator, which may take the form of an LED.

Other circuit configurations may be used as well with the assemblies described herein. In another example, pin 4 of the rectifier circuit 606 may be grounded through a capacitor and the input to the rectifier circuit 606 may be through a transformer and capacitor across pins 1 and 2 of the rectifier circuit 606. These variations help to reduce any EMI that may occur in the circuit.

The lighting circuit 302 in conjunction with the battery assembly provide a convenient supplemental light source, including for use as a backup or emergency lighting system. The exemplary circuits provide a small package that can be placed in a number of locations, including existing light fixtures or other support structures. It includes a universal input for accepting voltages between 110-277 VAC as well as differing frequencies, such as 47-63 Hz, but LED arrays and other low-voltage light sources make efficient use of available power, such as from electrical storage devices. LEDs, for example, can operate at less than six volts. Other light sources can also be used. The rechargeable battery supply is charged from the low-voltage side of the circuit 302 and provides current to the MOSFET through the same secondary side. Consequently, removing or installing a battery is less likely to produce a shock to the user. The emergency lighting system can be installed and made operational without having to change connections in existing light fixtures, and compatibility with existing light sources is not an issue. Additionally, having the rechargeable batteries, lighting circuit 302 and the light source as separate and connectable components permits easy installation and maintenance. The use of separate batteries allows smaller packages and easier replacement when components wear out. Different charging circuits or configurations can be provided so that a single lighting circuit can accommodate different battery sizes. An integrated socket makes installation of different battery sizes into the same lighting circuit easy, and less subject to error.

Having a lighting circuit that accommodates different sized battery packs allows more flexibility in meeting particular lighting requirements for a given area. Lighting circuits, battery supplies and light sources can be mixed and matched even for a single area to produce the desired light output in the desired locations. A single lighting circuit that can be configured as desired for different reference voltages provides greater flexibility in design and application. For example, conventional down light fixtures are generally positioned closer together than linear fluorescent fixtures, and backup lighting for down light fixtures can be designed or configured for lower light output because they would be closer together, where a backup light fixture is provided for each down light fixture. Conversely, backup lighting for linear fluorescent fixtures may need larger light sources and larger rechargeable battery supplies to produce the desired light output for the desired amount of time. As a further design benefit, a single lighting circuit that can be configured for different reference voltages permits easier maintenance and even greater ease in reconfiguring a previously installed assembly.

For assembly of the present examples, the lighting circuit 302 is provided with the desired combination of light source and storage battery assembly, along with the desired test button and indicator combination. The test button and indicator combination may typically be generic for any of the lighting systems herein. The storage battery and storage battery connector combination form a storage battery assembly, and the battery connector 330 is wired in such a way that the jumper 632 is connected to select the proper reference voltage for the particular battery size. In the example shown in FIG. 6A, the jumper 632 connects the resistor R12 630. That resistor will then determine the reference voltage for the charging circuit. Thereafter, installation of that battery in any lighting circuit designed with the battery assembly in mind will set the reference voltage. Likewise, other battery sizes can have their connectors 330 wired with respective jumpers to select a reference voltage in accordance with the particular battery size. Such other batteries can be installed with the first lighting circuit or any other similarly configured lighting circuit, thereby setting the reference voltage corresponding to the particular storage battery to which the connector 330 is attached.

The lighting circuit, light source, storage battery assembly, and test assembly can then be installed at a designated location. The light source is installed on a support surface for illuminating the designated area. The light source can be installed in an existing fixture, for example as a trim piece, on a fixture surface, from a socket or other fixture component, or in any other convenient means. The light source can also be installed separate from any existing fixture. The test assembly and indicator may be installed in a visible area and connected to the lighting circuit for easy access to a user, or may be installed out of sight, for example behind a fixture wall, or it can be omitted, for example in non-emergency applications. The test switch is configured to be normally open and momentary. The lighting circuit and battery storage assembly can also be installed and supported as desired, for example by way of an existing fixture or otherwise on a suitable support service. A suitable connection to the main supply panel can be made as desired, and the complete assembly connected and tested as necessary. Thereafter, battery assemblies can be replaced as desired, as can the light source (and even the entire assembly). Additionally, the illumination configuration of the assembly can be modified by replacing the light source with a light source having a different output/configuration and replacing the rechargeable battery supply with one suitable for the new light source, if necessary.

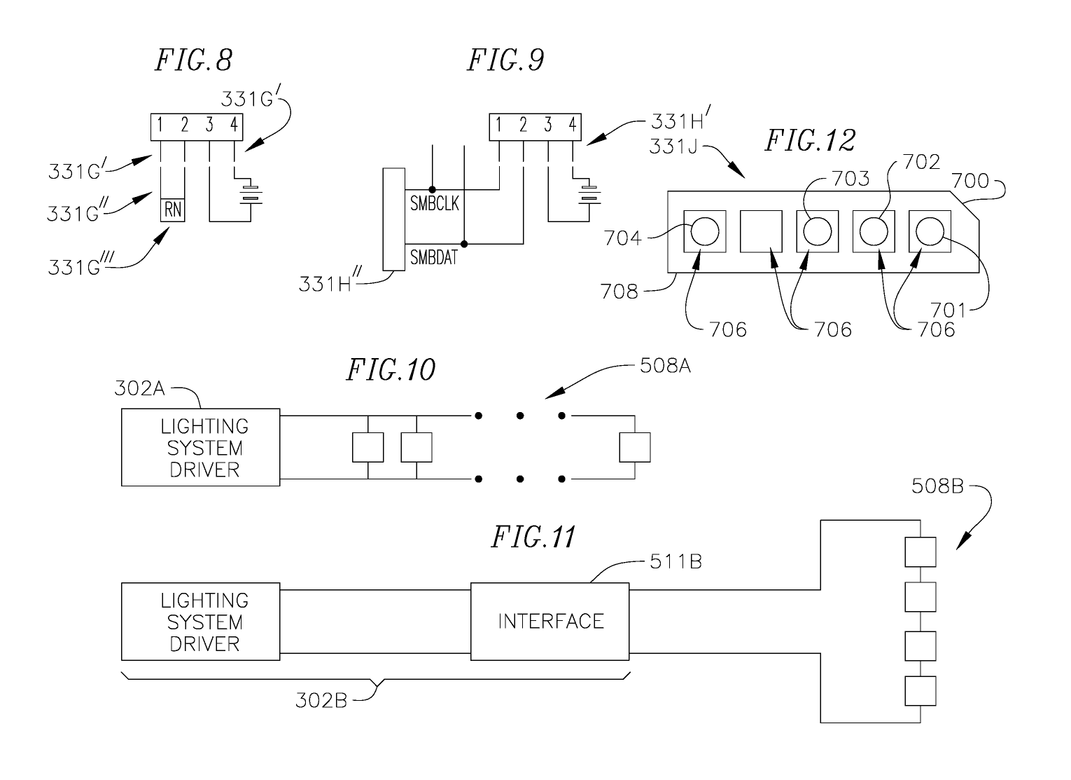

In LED arrays with which the circuit described with respect to FIG. 6 is used efficiently, the LEDs are coupled in parallel with suitable resistances associated with each LED. As shown in FIG. 10, the lighting circuit 302A applies a substantially nominally constant voltage to the array 508A. The voltage is well matched to white LEDs with a forward voltage less than the nominal 4.8V supplied by a NiCd battery pack, for example. To control current in the constant voltage system, small resistors are added in series with each LED. All the LEDs in the array 508A are connected in parallel and the lighting circuit can be used to drive the LED array directly, in other words without any additional components between the lighting circuit output and the LED array. This is because the output of the lighting circuit is well matched to white LEDs with which it can be used.

Other LED arrays than parallel-configured arrays can be used as well with the lighting circuit described with respect to FIG. 6. For example, series-connected LEDs can be used as a suitable light source, configured in a way such as that depicted in FIG. 11. As depicted in FIG. 11, the lighting circuit 302B drives a series-coupled LED array 508B through an interface 511B (FIG. 5) configured as a constant current boost converter (an example of which is described below). The converter takes the constant voltage output of the lighting circuit and converts it to a constant current output for application to the series-connected LED array.

A “boost converter” converts the constant voltage output of the lighting circuit to a constant current at a higher voltage suitable for driving a series string of LEDs without series resistors. It can be appreciated that the simplicity of adding this circuit can help to reduce SKUs and adds to the “plug and play” simplicity of the system.

The “boost converter” may also convert the constant voltage output of the lighting circuit to a new, higher or lower constant voltage suitable for driving a different number type or arrangement of LEDs. As described herein, the different type or arrangement or other lighting configuration can be identified or designated to the system by a suitable connector or other indicator, for example that may be part of the light source.

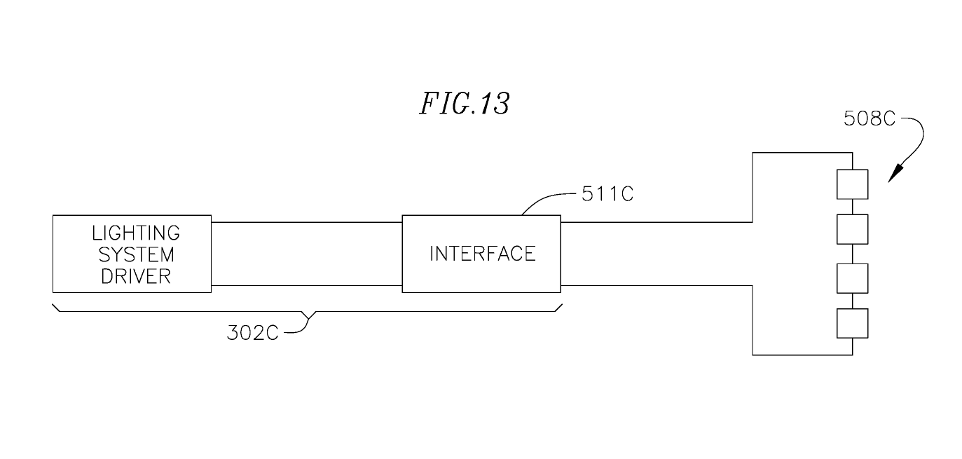

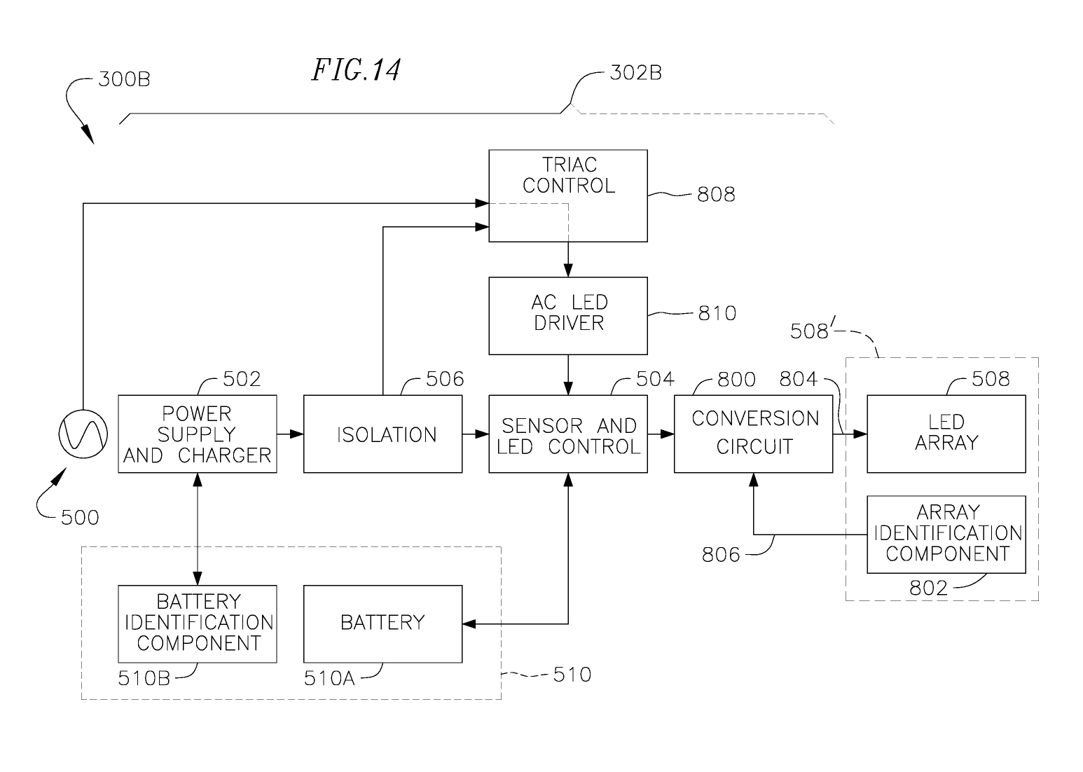

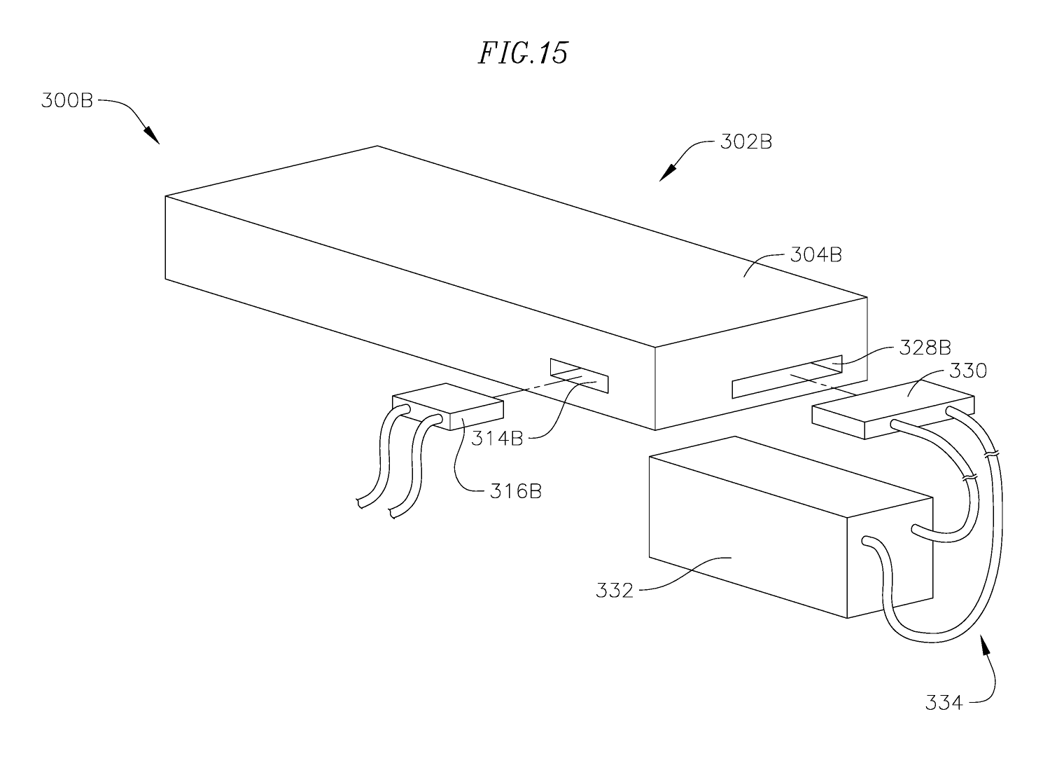

The “boost converter” may also convert the constant voltage output of the lighting circuit to a constant power suitable for driving various numbers and arrangements of LEDs (FIG. 13). The lighting circuit 302C drives a series-coupled LED array 508C, for example, through an interface 511C configured as a constant power converter. The converter takes the constant voltage output of the lighting circuit such as that described with respect to FIGS. 5-6 and converts it to a current output and calculates a target power as an output for application to the series-connected LED array. This power could be used to drive a small number of LEDs at a high power per LED or a larger number of LEDs at a lower power per LED or an array of LEDs of one power level, such as half watt LEDs, or an array of LEDs of another power level, such as one watt LEDs. The power per LED could be chosen for optimal luminous efficiency in a given application. Such selection of power per LED can possibly be designated by a suitable connector or other designator as described herein.

It can be appreciated that additional pins on the LED array connector 314 can be used to match the output characteristic of the aforementioned constant current or constant power circuits to the specific LED array being plugged into the LED array connector 314. These additional pins can be used in ways analogous to the methods described earlier allowing the configuration of the battery pack connector 330/331 to select an appropriate charging regime for the battery pack. For example, one implementation would be a jumper between two additional pins incorporated into the LED array connector 316 for an LED array that desires constant current, the presence or absence of which jumper would select, as one example, 350 mA or 700 mA, respectively, of constant current to be provided to the LED array via the LED array connector. Generally, the additional pins in the LED array connector 314 can be used to select or communicate the voltage, current or power desired for the LED array which is plugged into the LED array connector 314 to the LED driver circuit which drives the LED array and provides a specific voltage, current, power or other output to the LED array via the LED array connector.

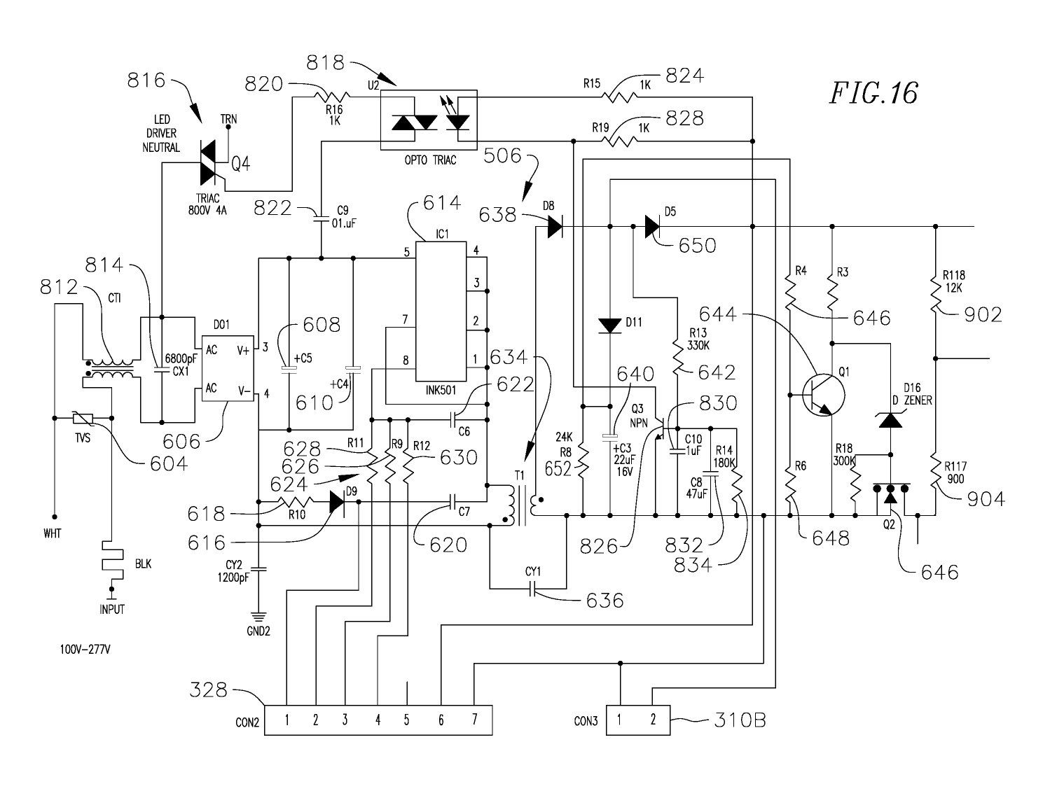

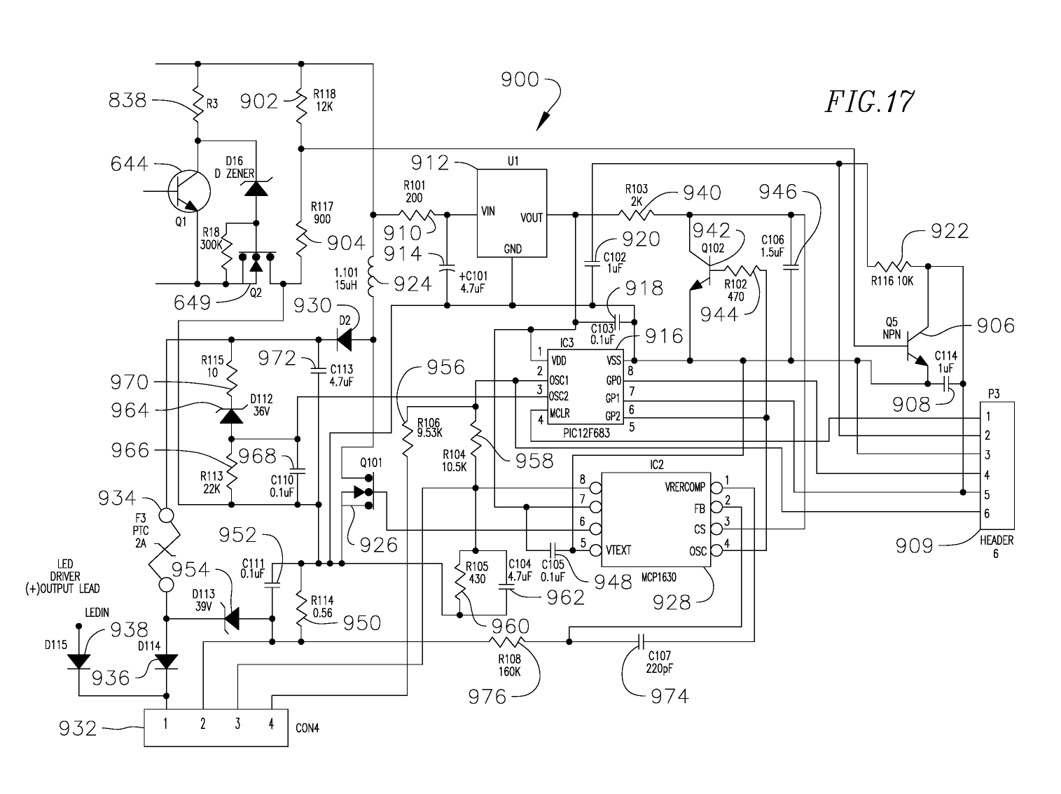

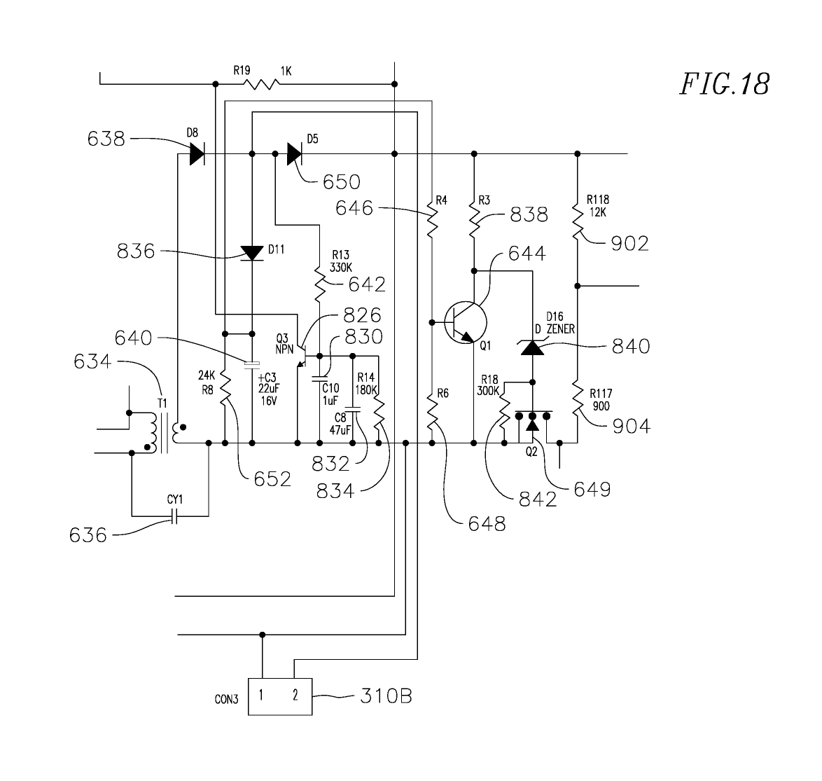

In another example of an emergency lighting system (FIGS. 14-15), a lighting system 300B and electrical circuit assembly 302B are contained in and supported by a housing 304B. (Various elements of FIGS. 14-21 include components identical or comparable to those described above with respect to the assembly in FIGS. 3-13, and the same or similar structures have identical numbers where the structures and functions are substantially identical, and structures having similar functions have identical numbers with a suffix added (for example, A or prime) where the functions have been modified and are no longer precisely identical.) The electrical circuit is described more fully below in conjunction with FIGS. 16-18. In the present example, the housing wall includes a plurality of openings in which are mounted respective sockets for receiving respective connectors, in a manner and having configurations such as those described herein. In the present example, each of the openings and their respective sockets in the housing 304B are distinct and different from each of the others. Additionally, in the present example, each of the sockets and the corresponding connectors are keyed, polarized or otherwise shaped so as to permit complete connection only in a single orientation. In the present example, fewer connections are provided than those for the system of FIGS. 3-4, and the present example can be used in place of the configuration of FIGS. 3-4, or the configuration of FIGS. 3-4 can be used in the present example.

The lighting system 300B includes an opening for providing access to a light source socket 314B supported in housing 304B The light socket 314B is configured to receive and support a light source connector 316B, which in turn is connected to a light source, for example a light source 318 shown in FIG. 4, or any other appropriate light source. In the present example, the connector 316B is a connector configured not only to provide power or energize the light source, but also to designate or indicate to the electrical circuit for powering the light source one or more characteristics or configurations of the light source. Alternatively, the light source connector 316B can be configured according to any of the other examples described herein or as desired to accomplish one or more of the functions described herein.

In an example of a connector for a light source configured to identify or designate one or more characteristics of the light source, the connector may have a contact element or plurality of contact elements for coupling with circuit components in the electrical circuit assembly. The connector includes a first plurality of contact elements for receiving power from the electrical circuit assembly for powering the light source and a second contact element or second plurality of contact elements configured to designate or indicate to the electrical circuit assembly one or more characteristics of the light source. The second contact element or second plurality of contact elements may be configured as indicators by either a positional indicating system or an electronic indicating system. The connector 3166 can take any of the configurations described above with respect to FIGS. 6-9 where the battery assembly is replaced by the light source in the present example, and the remaining one or more positions in the connector are used for designating a characteristic of the light source. A positional indicator configuration can be adopted according to one or another of the connector configurations of FIGS. 6 and 7, or an electronic indicator configuration can be adopted according to one or another of the connector configurations of FIGS. 8 and 9. Other possible indicator configurations will be apparent to those skilled in the art after considering the examples provided herein.

The light source connector 316B can be configured for either a positional indicator configuration or an electronic indicator configuration so as to set a circuit configuration in the electrical circuit assembly to set a circuit configuration. In one example, the light source connector 316B sets an output current, and in another example, the light source connector 316B sets an output voltage for the light source or in a further example, the connector 316B sets an output power to be produced by the electrical circuit assembly. Where the light source connector is used with a light source driven most efficiently with a constant voltage, the electrical circuit assembly of FIG. 5 would be used. Where the light source connector is combined with a light source driven most efficiently with a constant current, the electrical assembly of FIGS. 16-18 would be used (described more fully below). Where the light source connector is combined with a light source driven most efficiently with a constant power, the electrical circuit assembly of FIGS. 16-18 modified to produce a constant power output would be used.

For a given electrical circuit assembly, for driving or energizing a light source, appropriate settings for a number of different light sources can be made for the circuit. The settings can be made simply by using the connector for a given light source configuration to indicate to the electrical circuit assembly the required output for the given light source. For example, the connector can have positional indicators or electronic indicators for indicating to the electrical circuit assembly the particular characteristics of the light source with which the connector is associated. In this way, for example, the connector can indicate to the electrical circuit assembly whether the light source is an LED array or another form of light source, the size of the light source, whether the light source is to be driven with a constant current, constant voltage or constant power, or other light source characteristics. For a given light source configuration, its connector configuration is predetermined to correspond to the electrical circuit assembly to which it is to be connected for proper operation, and the connector configuration includes means for indicating to the electrical circuit assembly the desired setting for the electrical circuit assembly to provide the necessary output for driving the light source. The indicating means may be positional or electronic, as described herein, and the electrical circuit assembly and the acceptable connector configurations are predetermined to produce the desired output for driving the light source.

The lighting system 300B further includes an opening for providing access to a battery socket 328 (FIG. 15) supported in the housing 304B. In the present example, the battery assembly 334 including the battery socket 328, battery connector 330 and the storage battery 332 are substantially the same in structure and function as those described herein.

The lighting system 300B and its electrical assembly 302B can take a number of configurations. In the example shown in FIG. 14, the lighting system receives power during normal operating conditions from the power source 500 at the primary circuit in the power supply and charger circuit 502. The power supply and charger circuit 502 is coupled to the secondary circuit in the form of the sensor and LED control circuit 504 through the isolation circuit 506. In the present example, the interface 511 (FIG. 5) takes the form of a conversion circuit 800 (FIG. 14) taking the constant voltage output from the sensor and LED control circuit 504 to produce a constant current output. The constant current output is provided to a light source in the form of an LED array assembly 508′, in the present example including the LED array 508 and an array identification component 802. In the present examples, the light source in the form of the LED array assembly 508′ is coupled to the conversion circuit 800 through a single connector assembly, which includes contacts for powering the LED array 508, represented by line 804, and one or more contacts for indicating or designating to the conversion circuit 800 one or more characteristics of the LED array 508, which indication or designation is represented by line 806. Alternatively, the power for the LED array and the indicating function for the component 802 can be carried out through discreet and separate contact structures. However, in the examples described herein, the power for the LED array 508 and the indicator or designator for the conversion circuit will be considered to be in the same structure coupling the LED array assembly 508′ to the electrical circuit assembly 302B.

The assembly 510 includes an electrical storage element, such as the battery 510A described above, coupled to the sensor and LED control circuit 504, and has the same or similar structure and function as that described above with respect to FIGS. 1-13. The battery identification component 5106 has substantially the same structure and function as that described above with respect to FIGS. 1-13, but it should be understood that the lighting system 300B can operate with a conventional backup power supply.

The lighting system 300B in the present example also includes a control circuit 808 coupled between the power source 500 and a conventional AC LED driver circuit 810. The driver circuit 810 provides power to the LED array 508 so that the LED array 508 serves as the normal, everyday lighting source with which the present system is used. The control circuit 808 is placed in line with one of the incoming power circuits for the normal AC LED driver. The control circuit also receives input from the isolation circuit 506. In the present examples described herein, the control circuit 808 is a triac control circuit. The control circuit provides a delay in starting up the AC LED driver unit 810, and controls the input power to that driver. More specifically, the control circuit 808 provides a delay from when power is first provided from the supply 500 to the time when the AC LED driver 810 energizes the LED array 508 for illumination. This helps to minimize the possibility of the LED array 508 being driven by both the AC LED driver 810 and power from the conversion circuit 800. Delay allows the backup power sufficient time to turn off when normal power returns from the source 500, for example after a power outage or a test. The control circuit also turns off the normal AC LED driver circuit when normal power drops below a selected point or when a test switch pilot light (TS/PL) is pressed or activated.

In the present example, the isolation circuit 506 takes the form of the transformer 634 (FIG. 16) having substantially the same structure and function as that described with respect to the transformer in FIG. 6. Where the light source 508B is an LED array or other low-voltage light source, the isolation circuit 506 isolates the primary and secondary circuits and helps to protect the sensor and LED control circuit in the LED array 508B from the high voltage and current in the primary circuit of the power supply and charger circuit 502. Other isolation configurations can be used, including capacitive isolation.

The power supply and charger circuit in the example of FIG. 16 is on the primary side of the transformer 634 and includes a universal charger for the battery assembly 510, substantially the same as that described above with respect to FIG. 6. The primary circuit, depicted in FIG. 16, includes surge protection, EMI filtering, flyback controller and the triac control. The flyback circuit provides low voltage DC output to the secondary circuit and receives power from the main power supply input. The input can range between 100 V and 277 V. The TVS diode 604 is a 440 V and 400 W TVS diode to protect the circuit from voltage spikes over 440 V. The TVS diode is coupled across the input, which is then coupled to a common mode EMI filter including transformer 812 and capacitor 814. The filtered power is input to the bridge rectifier diode 606. Capacitors 608 and 610 provide a DC bus filter.

The flyback control circuit includes the integrated circuit 614, capacitors 620 and 622, diode 616, resistor 618 resistors 626, 628 and 630 and the transformer 634. As discussed previously, resistors 624 provide a current reference to the integrated circuit 614 for selecting different output currents from the flyback circuit. In one example, a jumper through the connector on the battery assembly between pins 1 and 2 of the connector 328 allow approximately 180 milliamp constant current output, a jumper between pins 1 and 3 allow approximately 145 milliamp and a jumper between pins 1 and 4 allow approximately 50 milliamp of constant current output. Other configurations can be adopted as discussed herein.

The triac control circuit 808 includes a triac 816 coupled between the common mode EMI filter and an Opto triac 818 through a resistor 820. The triac 816 is also coupled to the normal LED driver circuit neutral, thereby allowing the triac control circuit to control the power going to the normal LED driver circuit. The primary side of the Opto triac 18 is also coupled through a capacitor 822 between capacitors 608 and 610. One side of the optical element of the Opto triac 818 is coupled through a resistor 824 to pin 6 of the battery connector 328. The other side of the optical element of the Opto triac 818 is coupled through a transistor 826 to one side of the transformer 634. A resistor 828 is connected between the collector of the transistor 826 and pin 6 of the battery connector 328. The base of the transistor 826 is coupled to the transformer 634 through a parallel circuit of capacitors 830 and 832 and resistor 834. The base is also coupled through resistor 642 between diodes 638 and 650. The triac control circuit provides a delay in operation of the normal LED driver circuit, the neutral of which is coupled to the triac 816. The triac control circuit controls the input power to the normal LED driver, and also can turn off the normal LED driver when the test switch pilot light 310B (FIG. 16) is pressed.

In operation, when AC power is applied to the input of the primary circuit, there is a voltage across the output transformer 634. Resistors 642 and 834 and capacitor 832 provide a delay in turning on transistor 826. When input voltage is first applied, current passes through resistor 642 and charges capacitor 832. After about one second, capacitor 832 is charged and the current threshold of the base of transistor 826 is passed to turn on the transistor 826, and also to turn on the LED in the Opto triac 818. After the delay, triac 816 is turned on to power the normal LED driver. Capacitor 822 and resistor 820 limit the current to the gate of the triac 816. Additionally, during a power outage or a test, such as when the test switch pilot light 3106 is depressed, the voltage across capacitor 832 drains, thereby turning off transistor 826, which in turn turns off the Opto triac 818 and the triac 816. With the loss of power to the LED driver, the backup system will illuminate the LED array 508, as discussed previously. The point at which the Opto triac is turned off can be selected by suitable choice of values for the capacitor 832 and resistor 834. For example, the Opto triac can be turned off before the normal AC LED driver stops driving the LED array, for example when the LED output drops below a certain level.

In the present example, the sensor and LED control circuit 504 (FIG. 5) has similar components and functions as described previously with respect to FIG. 6. Specifically, as shown in FIG. 18, the present example includes a diode 836 coupled between diodes 638 and 650 and to capacitor 640. Additionally, a resistor 838 is coupled between the diode 650 and the collector of transistor 644. A Zener diode 840 is coupled between the collector of the transistor 644 and the MOSFET 649, and a resistor 842 is coupled between the gate of the MOSFET 649 and the secondary of the transformer 634. In operation, the diode 638 rectifies the AC output of the flyback circuit during the charging state. Resistors 646, 648, 838 and 842, transistor 644, MOSFET 649 and diode 840 detect power outages at the incoming power supply 500. Specifically, during the charging state when regular power is available, current is applied to the base of the transistor 644, pulling a gate of the MOSFET to ground, essentially turning off the MOSFET 649. In this configuration, no voltage is applied to the boost circuit (FIG. 17), described more fully below, from the battery backup. However, when power is lost from the main power supply connector, the voltage on the capacitor 640 trains through resistor 652, thereby dropping the voltage on the base of the transistor 644. The gate of the MOSFET 649 will no longer be a ground, and the MOSFET will begin to conduct, thereby providing current to the LED array by the pull-up resister 838, which pulls the MOSFET gate to Vbatt, thereby turning it on. Consequently, in the event of a power failure, transistor 644 cannot pull the gate of the MOSFET 649 to ground, allowing voltage at the gate of the MOSFET. The MOSFET then turns on to supply current to the light source from the battery.

A delay circuit is incorporated in the control circuit shown in FIG. 18 so that when normal power to the LED array drops below a given level, battery power does not immediately energize the LED array. The delay reduces the possibility that normal power and battery power are applied to the LED array at the same time. Specifically, diode 836, capacitor 640 and resistor 652 provide a delay circuit. When normal AC power is applied to the circuit, for example after being off or after a power outage condition, capacitor 640 charges. Thereafter, there is enough current to turn on transistor 644, which turns off the MOSFET 649. Normal power then energizes the LED array. When a power outage condition occurs, or when the test button is pressed, capacitor 640 drains in about one second. Once the capacitor drains to the point where it is no longer able to drive the base of the transistor 644, the transistor turns off, which in turn allows the voltage at resistor 838 to reach the gate of the MOSFET 649. The MOSFET 649 then turns on allowing the battery power to reach the boost circuit which then energizes the LED array. The one second delay in applying emergency power to the LED array helps to reduce the possibility of the LED array being energized by both external power and battery power during switchover from normal power to emergency power.

When the LED array is energized through battery power, the battery assembly begins to drain. In the example shown in FIGS. 16-18, the Zener diode 840, a 5.6 V Zener diode, turns off the boost circuit once the battery voltage drops below approximately 7 V. This helps to reduce the possibility that a three cell battery pack does not drop below 6 V and irreparably damage the battery cells, where the battery cell chemistry determines that they should not be discharged below two volts per cell. Other protections can be used for the battery assembly, or battery protection can be omitted if desired.

In the present example, a boost circuit 900 (FIG. 17) is provided to more efficiently energize an LED array, by boosting the voltage from the sensor and LED control circuit 504 and producing a constant current, for example where the LED array is also powered by a normal LED driver circuit, such as one known to those skilled in the art. The boost circuit 900 includes a resistor 902 and 904 (FIGS. 16 and 18) coupled across the transformer 634. Resistor 902 is coupled between the diode 650 and the MOSFET 649 through resistor 904. The base of a transistor 906 is coupled between resistors 902 and 904, and the emitter of the transistor 906 is coupled through a capacitor 908 to pin 5 of a programming port header 909.

The diode 650 (FIG. 18) is also coupled through a resistor 910 to the voltage input of a 5 V voltage regulator 912 (FIG. 17) and a capacitor 914 is coupled between the input and ground for the voltage regulator. The Vout pin of the voltage regulator is coupled to the VDD pin of a programmable interface controller 916, in the present example a PIC12F683 interface controller, the 2007 Microchip Technology Inc. datasheet specification of which is incorporated herein by reference. A capacitor 918 is coupled across the VDD and VSS pins of the controller 916. The VSS pin 8 of the controller is also coupled through capacitor 920 to the collector of the transistor 906 through resistor 922, and also to pin 2 of the programming header 909.

The diode 650 (FIG. 18) is also coupled through an inductor 924 to a MOSFET 926, the gate of which is coupled to pin 6 of a pulse width modulator 928. The pulse width modulator in the present example is a Microchip Technology Inc. MCP 1630, the 2005 specification of which is incorporated herein by reference. A diode 930 is coupled between the inductor 924 and, in the present example, pin 1 of a connector 932 through a positive temperature coefficient device 934, which provides recoverable short circuit protection, and diode 936. The controller, pulse width modulator, MOSFET 926 inductor 924 and diode 930 effectively form the boost topology of the boost circuit 900. The boost circuit 900 takes the constant voltage output of the sensor and LED control 504 and boosts it to a constant current output for the LED array 508, for example so that the output is comparable to that of the normal LED driver driving the LED array during normal operation. The normal LED driving circuit is coupled also to pin 1 of the connector 932 through diode 938. The diodes 936 and 938 prevent current feedback from the normal LED driver circuit into the boost circuit 900 during normal operation, and current feedback from the boost circuit to the normal LED driver circuit when the boost circuit is operating.

Considering the boost circuit in more detail, the Vout of the voltage regulator 912 is coupled to pin 3 of the modulator 928 through resistor 940. The collector emitter circuit of a transistor 942 is coupled between the resistor 940 and the VSS pin of the controller 916, which is also connected to pin 3 of the programming header 909. The base of the transistor 942 is coupled through a resistor 944 to the oscillator pin 4 of the pulse width modulator 928. A capacitor 946 is coupled in parallel with the collector emitter circuit of the transistor 942, between the resistor 940 and the VSS pin of the controller.

The Vout of the voltage regulator 912 is also coupled to pin 7 of the pulse width modulator 928 and through capacitor 948 to the Vtext pin 5 of the modulator. The VSS pin of the controller 916 is also coupled to the Vtext pin 5 of the pulse width modulator. Additionally, the ground pin of the voltage regulator is coupled through a parallel resistor capacitor network of resistor 950 and capacitor 952 to pin 2 of the light source connector 932. A Zener diode 954 is coupled between pin 2 of the connector 932 and a point between the positive temperature coefficient device 934 and diode 936. The Zener diode 954 is a 39 volt Zener that eliminates voltage pulses over 39 volts, which might be found during no load conditions.

The oscillator 1 pin 2 of the controller 916 is coupled through a resistor 956 to pin 4 of the light source connector 932. It is also connected through resistor 958 to pin 3 of the light source connector 932 and to pin 8 of the pulse width modulator 928. It is also coupled through a resistor capacitor circuit of resistor 960 and capacitor 962 to the ground circuit of the voltage regulator 912.

The oscillator 2 pin 3 of the controller is coupled between a Zener diode 964 and a resistor 966. It is also connected to a capacitor 968. The resistor 966 and capacitor 968 are coupled between the MOSFET 649 and resistor 904. The opposite side of the Zener diode 964 is coupled through resistor 970 to the positive temperature coefficient device 934. A capacitor 972 is coupled between the diode 930 and resistor 970 on one side, and on the other side to the ground circuit of the voltage regulator 912.

The programming header 909 is coupled to appropriate pins of the controller 916 as shown in FIG. 17. The connections are made in order to properly program the controller 916.

The Vrercomp pin 1 of the modulator 928 is coupled through a capacitor 974 and resistor 976 to pin 2 of the light source connector 932. The FB pin 2 of the modulator 928 is coupled between the capacitor 974 and the resistor 976.

In operation, the controller controls several aspects of the boost circuit, including providing a reference switching frequency, a maximum duty cycle, over voltage detection, voltage reference for constant current and dimming during low battery voltage. Other devices can be used to provide these functions, but the controller 916 will be described in the present example for these purposes. Over voltage detection is provided by the circuit that includes resistor 970, Zener diode 964, resistor 966 and capacitor 968. When the output voltage from the sensor and LED control circuit 504, from the diode 650, exceeds 36 V, there is current breakthrough at Zener diode 964. Then when the voltage on pin 3 of the controller 916 reaches approximately 1 V, an over-voltage flag is set in the controller's firmware, shutting down the switching frequency reference clock to the controller until the voltage drops back to zero.

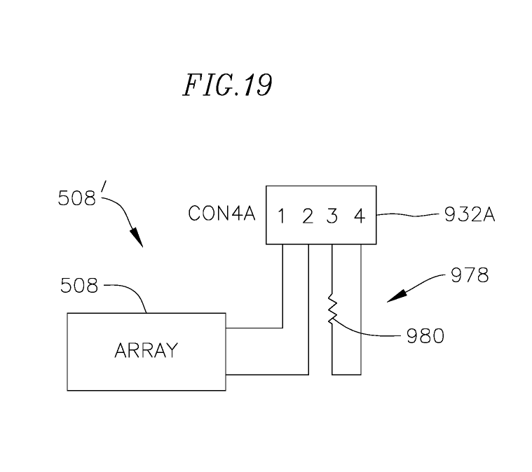

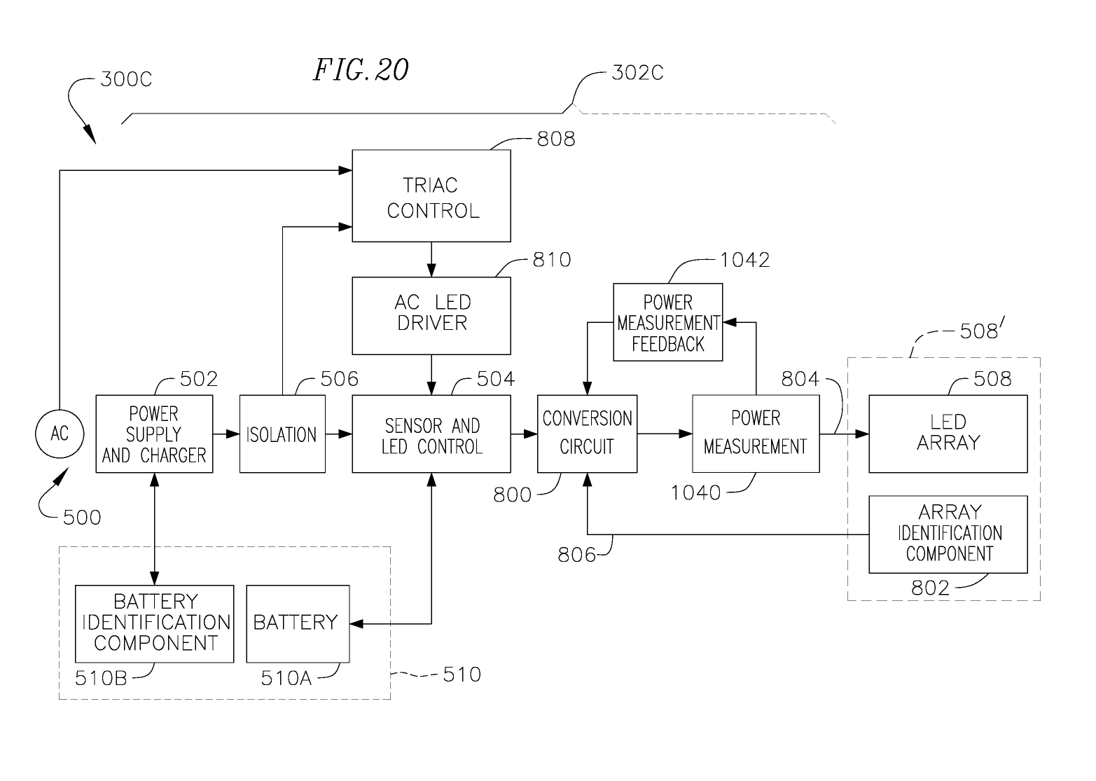

A voltage reference for the controller is provided by resistors 956, 958 and 960 and capacitor 962. The voltage reference sets a constant current output. The voltage reference makes a voltage divider circuit to provide the voltage reference to pin 8 of the pulse width modulator 928. A jumper on the connector 932A connecting to the light source connector 932 between pins 3 and 4 allows for an output current setting of approximately 700 milliamps (FIG. 19). Examples of connectors connecting into the electrical circuit assembly and having jumpers are shown in FIGS. 6 and 7. Connectors having such jumpers can be incorporated into a mating connector for connector 932 where the jumper designates the constant current to be output to the LED array through pins 1 and 2 of the connector 932. Other mating connector configurations can be used to designate to the boost circuit other constant current outputs.

The lighting system 300B includes a battery low voltage detection circuit, which may be considered part of that boost circuit 900 or the sensor and LED control circuit (FIG. 17). In the present example, the battery voltage detection circuit includes resistors 902, and 904 and 922 and the transistor 906. Other components can be used in addition to or instead of these components, but in the present example, resistors 902 and 904 form a voltage divider circuit and when the battery voltage is greater than approximately 9.2 V, the transistor 906 through capacitor 908 pulls pin 6 on the controller 916 to 0 V, which powers the LEDs in the array at full power, or whatever normal power level is set in the circuit for normal operation. When the battery voltage begins dropping below 9.2 V, the current to the base of transistor 906 drops below the threshold required to keep pin 6 at 0 V. Therefore, voltage begins to build on pin 6 of the controller as the battery voltage continues to drop. As the voltage on pin 6 increases, the controller 916 reduces the power applied to the LED array, based on instructions programmed into the controller 916.

Reducing the LED light output helps to protect the battery assembly. As the battery voltage starts to decrease, battery current ordinarily would increase to maintain the same output power, for example as set through the boost circuit 900. A higher current could reduce the overall efficiency of the circuit, and may also generate heat. In one example, the controller reduces the current to the LED array to approximately 70% of normal. Additionally, battery life may also be improved. Reducing the power to the LED array also helps to smooth the transition from full power or illumination to possibly zero power turning the LED array off when the battery voltage has decreased below a desired threshold. The power reduction and the battery threshold at which the backup circuit turns off the LED array can be selected as desired.

Pulse width modulation is carried out with the modulator 928, and resistors 950 and 976 and capacitors 952 and 974. These resistors and capacitors form a current sensing circuit for sensing the current across resister 950. The modulator 928 compares the voltage reference on pin 8 and the voltage measured on pin 2 to provide the correct duty cycle to the MOSFET 926.

The boost circuit also includes a ramp generator formed by transistor 942, resistors 940 and 944 and capacitor 946. The ramp generator provides a reference signal to a comparator input for the modulator 928. The modulator compares the ramp reference signal to an error amplifier output to generate the pulse width modulation signal.

An LED array indicator or designator can be included in an LED array assembly 508′ as part of the LED array 508 and a connector for connecting the array to the lighting system 300B. In the present example, a connector 932A is configured to connect with the connector 932 (FIG. 17), and includes pins 1 and 2 for receiving power from the lighting system (FIG. 19). The connector 932A also includes at least one additional pin, and in the present example two additional pins 3 and 4 for indicating or designating to the boost circuit 900 a characteristic of the array 508 that is being connected. The indication provided by pins 3 and 4 may be a positional reference or an electronic reference in ways similar to those described above with respect to FIGS. 6-9. In one example, a resistor circuit 978 connects pins 3 and 4 with a resistor 980. In the example described above where the connector 932A includes a jumper between pins 3 and 4 allowing for an output current setting of 700 milliamps, the value of resistor 980 is zero. A non-zero resistance value can be substituted for providing a different current setting, as desired. Other forms of a connector 932A can be used to supply power to the LED array 508 and also to indicate to the lighting circuit one or more characteristics of the LED array. Example characteristics include possible current levels, possible voltage levels, possible power levels, or other characteristics of the LED array. In the present example, the indicator is provided substantially integral or as part of the connector 932A, but the indicator can be formed separate from the power supply portion of the connector. However, having an indicator or designator included in the LED array package delivered to the user allows easy installation of the LED array and configuration of the lighting circuit to properly drive the array or other light source. Where the indicator function is part of the physical connector 932A, the indicator cannot be easily separated from the connector, thereby minimizing possible errors in configuring the boost circuit 900 for the LED array or other light source being connected to it.

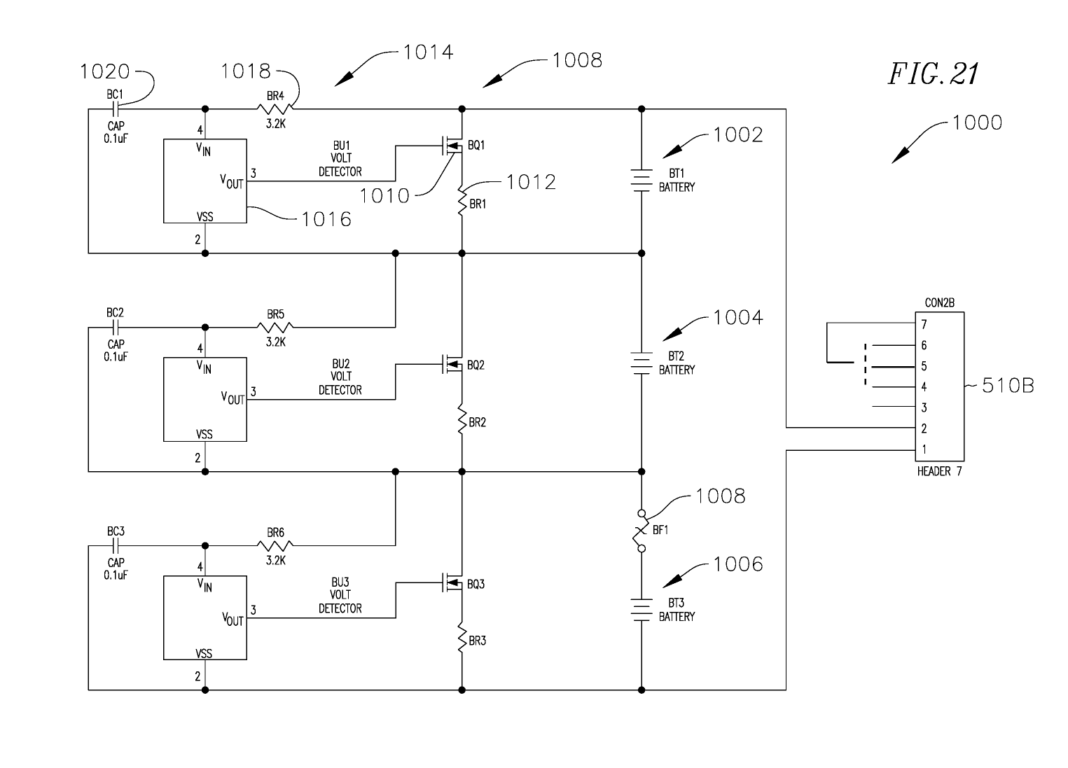

A lithium-ion battery assembly can be used with the lighting circuit described herein, or with other electronic components to be powered by a power source. In one example, a battery assembly 1000 can include at least one, and in the present illustrated example 3, lithium ion battery cells 1002, 1004 and 1006, providing battery storage for the lighting circuit (FIG. 21). The lithium-ion battery cells are rechargeable, and are well known in the art. In the present example, the battery assembly 1000 includes a connector 510B described above, but the connector configuration or other contacts for providing power to a circuit can be any conventional contact configuration, whether slotted or otherwise, especially where the battery designation or indication function is not desired. In the present example, the connector 510B is substantially the same as any of those described herein. The balance of the present discussion will be focused on a battery regulator circuit. In the present example, the charger circuit in the lighting circuit does not require adjustment merely because it might be operated with and charging a NiCad versus a Lithium Ion battery, because the Lithium Ion Battery assembly can be treated as though it were a NiCad battery.

The battery assembly 1000 will be encased within a secure housing substantially in a manner similar to existing housing or cases for such batteries. The battery cells, regulator circuit and connector or other contact construction represented by connector 510B can be formed to be all within a single housing or casing, or the connector or other contact construction can be coupled to the rest of the battery assembly through flexible cable or other conductors. In the present example, the connector 5106 will be considered to be coupled to the remainder of the battery assembly through a flexible conductor or other cable arrangement.

The batteries 1002-1006 are coupled in series to one another between pins 1 and 2 of the connector. A short circuit protection device 1008 is coupled in series between two of the batteries. Each of the batteries includes a regulator circuit 1008 coupled in parallel across the respective battery. Each regulator circuit is substantially identical to the others, but only one regulator circuit will be described for purposes of explanation. The regulator circuit includes the series connected MOSFET 1010 and resistor 1012 in parallel across the battery 1002. A voltage detection circuit 1014 is also coupled in parallel across the battery 1002 and includes a voltage detector 1016 having a Vout pin 3 coupled to the gate of the MOSFET. A resistor 1018 is coupled to one side of the battery and MOSFET and to the Vin pin 4 of the voltage detector. A capacitor 1020 connects Vin to VSS in the voltage detector, and VSS is coupled to resistor 1012 and to the second side of the battery 1002.

The battery regulator circuit allows the lithium-ion battery cell to be charged as though it were a NiCad battery, and a charger for a NiCad battery can be used for both NiCad and Lithium Ion batteries. Specifically, the lithium-ion cells can always be connected to a charging circuit without significantly deteriorating the quality of the battery. When the voltage level of the battery reaches approximately its maximum voltage level, the voltage regulator circuit 1014 shunts the current around the battery, for example to the next battery or back to the charging circuit. In the present example, low charge currents are applied to the battery assembly, resulting in relatively little power loss or waste once a battery cell is fully charged. With the battery regulator circuits incorporated in the battery assembly, the constant current charging circuit for the battery assembly becomes a constant current and constant voltage charging source. In the present example, the charge current is approximately 5% of the total capacity for the batteries.

In another example of a lighting circuit, for example for sensing and controlling an LED array, the lighting circuit of FIGS. 16-18 is used with additional circuit components for calculating, applying and maintaining a constant power output, for example for the LED array. For example, the lighting circuit can include a power measurement circuit 1040 between the conversion circuit 800 and the LED array 508′ (FIG. 20). The power measurement circuit 1040 can measure the resistance across pins of the array, or the equivalent, and measure a current through a resistor in series with the array, or the equivalent. During operation, the power measurement circuit monitors the voltage across the array, and firmware in a processor, such as processor 916, with the current, calculates the power applied to the LED array. During operation of the backup or emergency system, for example during a power outage, the conversion circuit produces the power for the LED array at the level used during normal operation, or at a level selected for emergency operation. During emergency operation, the power to the LED array is monitored, and that power is fed back to the conversion circuit 800, boost circuit 900 in FIG. 17, to adjust, if necessary, the current through and/or the voltage applied to the LED array. Adjustments are made until the desired power is achieved. In one example, a microcontroller is included in the boost circuit 900 to measure both the LED driver output voltage and current across the LED driver output, such as through Analog-to-Digital converters coupled to circuits monitoring a voltage and a current that correspond to a voltage and current for the LED array. The controller 916, or an additional controller, can then be used to compute voltage and current value to achieve a total output power. The total output power is then used as a target for the LED array, and the boost circuit 900 will take existing measured values for the existing voltage and the existing current, and adjust the output voltage and current to meet the target output power. By way of example, a 10 W constant power driver will automatically adjust the output voltage and current to achieve 10 W on the LED load. In another example, an integrated circuit can be used in the boost circuit 900, for example a Maxim MAX4210, to measure the output power and provide an analog signal to the controller 916. The controller will use the output power as a target output power for the LED array, and adjust the output voltage and current accordingly to meet the target output power.

It is also understood that the aforementioned constant current, constant power or other LED driver type circuits may be integral or separate from the other circuitry allowing flexibility of design and implementation to optimize cost, size, or other product characteristics.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

1-22. (canceled)

23. A lighting system comprising:
a rechargeable battery for powering the lighting system during low voltage or power outage conditions;
a light source;
a power supply circuit;
a lighting current supply circuit configured to receive power from the power supply circuit;
an isolation circuit between the power supply circuit and the lighting current supply circuit; and
a coupling element for coupling components in the power supply circuit and for coupling the rechargeable battery to the lighting current supply circuit.

24. The lighting system of claim 23 wherein the lighting current supply circuit is configured to normally keep the light source off.

25. The lighting system of claim 23 wherein the light source is an LED array.

26. The lighting system of claim 23 wherein the isolation circuit includes a transformer.

27. The lighting system of claim 23 wherein the power lighting current supply circuit includes a battery charging circuit.

28-32. (canceled)

33. A supplemental lighting system for area lighting, the system comprising:
a light source mounted to a support surface and positioned for illuminating an area for use when the light source is illuminated;
a driving circuit electrically coupled to the light source for providing current to the light source;
a charging circuit electrically coupled to the driving circuit;
a rechargeable electric storage device electrically coupled to the driving circuit and electrically coupled to the charging circuit; and
a connector having a first plurality connection slots, and a second plurality of connector elements wherein the second plurality is less than the first plurality and the remainder of the first plurality of connection slots are not used for a given rechargeable electric storage device.

34. The system of claim 33 wherein first and second connector elements in the second plurality of connector elements are coupled together through a jumper.

35. The system of claim 33 further including third and fourth connector elements in the second plurality of connector elements electrically coupled to the rechargeable electric storage device.

36. The system of claim 33 wherein the rechargeable electric storage device and the connector are secured together.

37. A supplemental lighting system for area lighting, the system comprising:
a light source mounted to a support surface and positioned for illuminating an area for use when the light source is illuminated;
a light source supply circuit electrically coupled to the light source for providing current to the light source;
a power supply circuit electrically coupled to the light source supply circuit with an isolation device between the power supply circuit and the light source supply circuit; and
a rechargeable electric storage device electrically coupled to the light source supply circuit and including a connector having at least two active contacts coupled together.

38. The supplemental lighting system of claim 37 wherein the light source is an LED light source.

39. The supplemental lighting system of claim 37 wherein the isolation device is a transformer.

40. The supplemental lighting system of claim 37 wherein the light source supply circuit includes a transistor.

41. The supplemental lighting system of claim 37 wherein the power supply circuit includes at least two separate circuit components for separately setting a voltage reference.

42. The supplemental lighting system of claim 41 wherein the at least two separate circuit components include two separate resistors.

43. The supplemental lighting system of claim 42 further including a third separate resister.

44. The supplemental lighting system of claim 43 wherein the first, second and third separate resistors correspond to different rechargeable electric storage devices having different voltages.

45. The supplemental lighting system of claim 37 wherein the connector includes a plurality of contact positions and wherein the connector includes at least first and second contact positions for respective different rechargeable electric storage device voltages, and third and fourth additional contact positions for respective connections to the light source driving circuit.

46. The supplemental lighting system of claim 37 wherein the rechargeable electric storage device is coupled to the light source supply circuit on a side of the isolation device opposite the power supply circuit.

47-108. (canceled)
